(19) United States
(12) Patent Application Publication
(10) Pub. No.: US 2005/0256893 A1
(43) Pub. Date: Nov. 17, 2005

(54) Method and system for updating hierarchical data structures

(76) Inventor: Russell Perry, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/117,110

(22) Filed: Apr. 28, 2005

(30) Foreign Application Priority Data
Apr. 30, 2004 (GB) 0409675.6

(51) Int. Cl. G06F 17/00

(52) U.S. Cl. 707/101

(57) ABSTRACT

Embodiments of the present disclosure provide systems and method for compressing a first data object. Briefly described, one embodiment of a method for compressing a first data object, among others, can be broadly summarized by the following steps: determining respective differences to be applied to at least one template that allow the first data object to be reconstructed; and forming a further data object identifying the at least one template together with the respective differences to be applied to the at least one template. Other methods and systems are also provided.

### CLAIM TO PRIORITY

This application claims priority to copending United Kingdom utility application entitled, “Method and System for Updating Hierarchical Data,” having serial number GB 0409675.6, filed Apr. 30, 2004, which is entirely incorporated by reference.

### TECHNICAL FIELD

This disclosure relates to a method of and system for updating hierarchical data structures, such as XML data structures.

### BACKGROUND

Data can often be represented as a hierarchical or “tree-like” structure. Such a structure can have a number of nodes representing data items, each node can have sub-nodes, each sub-node can have its own sub-nodes and so on. An example of a tree-like data structure 2 is shown in FIG. 1. The first node 4 is the highest level node or the “root” node. Sub-nodes 6 of the root node 4 can be represented by displaying “branches” 8 connecting each sub-node 6 with the root node 4. Sub-nodes 10 of one of the nodes 6 can be connected to the associated sub-node 6 with further branches 12. In this way any node in the whole data structure 2 can be reached by starting at the root node 4 and traversing the branches which pass through nodes of higher levels until the specific node is reached. This form of structure allows each and every element to be uniquely identified such that it can be investigated or altered. A node which has sub-nodes can be called the “parent” of its sub-nodes. The immediate sub-nodes are called “child” nodes of the parent. The root node is the highest node in the hierarchy.

An exemplary structure used to describe such a hierarchical structure within computer systems will now be described. The data structure is typically stored as a “file” in a computer's storage system such as a hard disk. Each node is identified within the data structure using a start and often also an end “tag.” These tags are indicia which describe the nature of their associated data. Data associated with each node lies between the start and end tags. Sub-nodes or children of a node have their tags and data adjacent the data associated with the parent and advantageously in between the parent's tags.

There are numerous ways of implementing a tree-like data structure. One common implementation is to use XML (Extensible Mark-up Language). XML is extensively used for representing, storing and exchanging data, especially when exchange occurs over the Internet.

There are many situations where parties to a transaction need to exchange messages or updates to a document. One way to achieve this is to modify the document and then resend the entirety of the document to the intended recipient. However this is very wasteful of memory and transmission bandwidth. Whilst for a single document neither of these may present themselves as difficult problems, for an organization dealing with large numbers of documents and/or transactions the data transmission and storage requirements may become costly to maintain or onerous to administer.

An example of an XML data structure embodying a product order document is shown in FIG. 2. XML defines data items by using start and end tags. XML uses a slightly different notation than general hierarchical data structures. Whereas each start tag, end tag, and data between start and end tags is normally called a node, in XML a data item comprising a start and end tag and (optionally) having data between them is called an “element.” Therefore the root node 4 of the data structure 2 in FIG. 1 would be called the root element if implemented using XML.

In the example shown in FIG. 2, XML is used to define a data structure representing an order form, having sub-elements for customer details, order details and other information. Each sub-element may have further sub-elements and so on. Alternatively, for example, for other documents, XML can be used to define documents or objects having elements for headings, sub-headings, paragraphs, and other components, such as graphics. XML uses both start tags and end tags to define an element. The start tag of an element consists of an element name enclosed within angled brackets. The end tag is identical to the start tag, except that a “/” character is added just before the element name. For example, the start and end tags for the root element of an order data structure such as that found in FIG. 2 could be <order> and </order> respectively. These tags are found in lines 2 and 15 respectively within FIG. 2. This data structure can be visualised as a tree-like structure with elements and branches as shown in FIG. 3.

In the XML data structure of FIG. 2, the first line “<?XML version=“1.0”?> indicates that the following information is in XML format. The first XML node is found in line 2. This node “<order>” is the start tag of the root element of the data structure. Any sub-elements of the root element are situated between the start and end tags of the root element. This includes the start tag, end tag, and any data associated with any sub-element.

A properly formed XML data structure does not allow a parent element to terminate (with its end tag) before any of its child elements. Thus, a child element can be easily associated with its parent, and can have only one immediate parent in the hierarchical level directly above the level of the child element. The XML data structure also specifies that each start tag must have an associated end tag. There is one exception to this rule. If there is no data between associated tags of an element, then the start and end tags can be replaced by a single “empty element” tag. This would comprise a start tag with an additional forward slash character following the element name. For example, <order/> would indicate an empty order data structure. A further type of node which may occur within an XML data structure is an attribute. Attributes are nodes which appear within the start tag of an element and convey some information about that element. Attribute names and their values can be chosen to be descriptive of the information they are conveying.

Data and sub-elements between the tags of elements in XML are often indented as shown in FIG. 2 to indicate to a human reader that the data is associated with the element. Such indentation is not required by a computer. Data and further sub-elements within the sub-elements can be further indented to highlight the structure of the XML data. This feature can be used together with descriptive element names in order to produce a data structure which can easily be interpreted and edited by a human without using special XML aware software or apparatus.

A side-effect of these features of XML is that XML documents or data structures tend to be relatively large when compared to often more compact forms for representing data sets. An XML data structure contains a lot of data (meta data) in tags and hence tends to be verbose. This has disadvantages when storing XML files as more storage space tends to be required by each file. Furthermore, when transferring the files using a communication medium such as the Internet, more information must be transmitted, which increases transmission time and consumes bandwidth.

Often a large amount of data to be transmitted is redundant. For example, a document publisher may wish to distribute copies of an updated version of an electronic document to users who possess an older version. The updated version may only contain a small number of changes over the older version. Therefore, much of the document distributed is already known to the users.

Tools exist that try to address this problem. One example consists of the “diff” and “patch” utilities which are used together for the purpose of updating an older file. “Diff” is used to list the differences between two computer files. “Patch” is used to apply the differences to one of the files to produce the other file. These tools can be used to update a distributed document by transmitting only the differences between an old and a new file to a user having the old file. The user can then apply the patch utility to produce an up-to-date file from the old file.

These utilities operate on a file at bit level and hence may identify changes in the bit sequence within a file that, in terms of the data conveyed by the file, make no substantive change. For example, within in XML document if a node in such a structure is moved relative to other nodes which have the same parent, then the data structure remains unchanged whereas the file embodying the data structure may have changed. Also, a data structure in XML may be represented in many different ways by changing the formatting using redundant white spaces as explained above. These differences do not alter the data structure at all, however the diff and patch utilities identify these differences. As a result, the differences which are distributed by these utilities for the updated file can be much more substantial than is necessary for updating a tree-like data structure.

A further disadvantage of the diff/patch and similar utilities is that the recipient of the differences needs to be in possession of the old version of the file to be updated. This can be a problem when several users receiving the differences are each in possession of a different version of the file to be updated.

Utilities exist which allow the exchange of differences between XML tree structures. An example is “XMLDiff” which can be found on the World Wide Web at IBM's alphaworks web site. A list of differences between two XML tree structures can include information on added nodes, deleted nodes and changed nodes. Thus, trivial differences in the files are ignored. The utility generates differences between two XML tree structures, and these differences can be applied to one of the tree structures to produce the other. Utilities as XMLDiff are typically used for updating remote documents, or viewing changes introduced into a new version of a document by comparing it with an older version. The recipient of a list of differences between old and new XML structures still needs to be in possession of the old structure. This does not address the problem relating to several users having different versions of a file to be updated.

An XML data structure may also be associated with a document type definition (DTD) or an XML schema. A DTD or schema defines the format of an XML data structure, such as the names of elements that can appear, where they can appear, the type of data they can contain, and other properties. Information on XML schemas can be found on on a web site maintained by the World Wide Web Consortium. A schema associated with an XML data structure may be explicitly defined with the XML data structure. Alternatively the two may be associated together by a user of the XML data structure. Tools exist which verify that an XML data structure complies with an XML schema.

### SUMMARY

Embodiments of the present disclosure provide systems and method for compressing a first data object. Briefly described, one embodiment of the system includes a data processor arranged to compress a first data object. The data processor is arranged to determine respective differences to be applied to at least one template that allow the first data object to be reconstructed and form a further data object identifying the at least one template together with the respective differences to be applied to the at least one template.

Embodiments of the present disclosure can also be viewed as providing methods for compressing a first data object. In this regard, one embodiment of such a method, among others, can be broadly summarized by the following steps: determining respective differences to be applied to at least one template that allow the first data object to be reconstructed; and forming a further data object identifying the at least one template together with the respective differences to be applied to the at least one template.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Various embodiments of the present disclosure will now be described by way of example only with reference to the accompanying drawings, in which:

FIG. 1 is a graphical example of a hierarchical data structure;

FIG. 2 shows an example of an XML data structure embodying a product enquiry;

FIG. 3 is a graphical representation of the XML data structure of FIG. 2;

FIG. 4 shows a prior-art situation where two parties exchange information;

FIG. 5 shows the XML data structure of FIG. 2, along with an XPath of each element;

FIG. 6 shows a situation where two parties exchange information according to a first embodiment of the present disclosure;

FIGS. 7 to 10 show example XML templates which are held by all parties when exchanging information according to one embodiment of the present disclosure;

FIG. 11 illustrates an example XML “diffdoc” used in an exchange of information according to one embodiment of the present disclosure;

FIG. 12 is a graphical representation of the diffdoc of FIG. 11;

FIG. 13 is a flow diagram of steps taken in a first stage of producing a diffdoc;

FIG. 14 is a flow diagram of steps taken in a second stage of producing a diffdoc;

FIG. 15 is a flow diagram of steps taken in a third stage of producing a diffdoc;

FIGS. 16A-16B show a table of instructions which can be present in the diffdoc;

FIG. 17 shows a table of the steps taken when carrying out instructions in the diffdoc of FIG. 11;

FIGS. 18 to 20 show the templates of FIGS. 7 to 9 respectively after they have been modified by the instructions in the diffdoc of FIG. 11;

FIGS. 21 and 22 show the templates of FIGS. 18 and 20 respectively, after they have been updated by a party to an exchange of information;

FIG. 23 shows an example of a second XML diffdoc for use in an exchange of information according to one embodiment of the present disclosure;

FIGS. 24 and 25 show the templates of FIGS. 10 and 21 respectively, after they have been updated by a further party to the exchange of information;

FIG. 26 is an example of a third XML diffdoc;

FIG. 27 shows a situation where multiple parties exchange information according to one embodiment of the present disclosure;

FIG. 28 shows an example of a second XML diffdoc for use in an exchange of information according to one embodiment of the present disclosure;

FIG. 29 shows an example of a third XML diffdoc for use in the one embodiment; and

FIG. 30 shows a computer system suitable for use with one embodiment of the present disclosure.

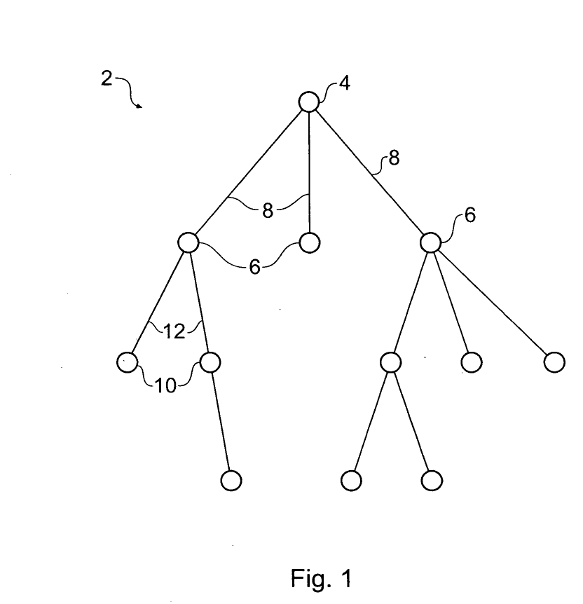

### DETAILED DESCRIPTION

According to a first aspect of one embodiment of the present disclosure, there is provided a method of compressing a first data object, comprising the steps of: determining respective differences to be applied to at least one template that allow the first data object to be reconstructed; and forming a further data object identifying the at least one template together with the respective differences to be applied to the at least one template.

According to a second aspect of one embodiment of the present disclosure, there is provided a data processor arranged to compress a first data object, wherein the data processor is arranged to determine respective differences to be applied to at least one template that allow the first data object to be reconstructed and form a further data object identifying the at least one template together with the respective differences to be applied to the at least one template.

According to a third aspect of one embodiment of the present disclosure, there is provided a computer program for controlling a data processor to perform a method of compressing a first data object, wherein the method comprises the steps of determining respective differences to be applied to at least one template that allow the first data object to be reconstructed and forming a further data object identifying the at least one template together with the respective differences to be applied to the at least one template.

According to a fourth aspect of one embodiment of the present disclosure, there is provided a method of reconstructing a first data object, comprising the steps of identifying at least one template from a further data object and applying respective differences identified in the further data object to the at least one template in order to reconstruct the first data object.

According to a fifth aspect of one embodiment of the present disclosure, there is provided a data processor arranged to reconstruct a first data object, in which the data processor is arranged to identify at least one template from a further data object and apply respective differences identified in the further data object to the at least one template in order to reconstruct the first data object.

According to a sixth aspect of one embodiment of the present disclosure, there is provided a method of exchanging information between a first party and a second party, where the first and second parties each possess a copy of at least one template, and the first party possesses a first data object which comprises or is mapable onto the at least one template together with respective differences to be applied to the at least one template, and the method comprises the steps of: the first party determining the respective differences to be applied to the at least one template; the first party forming a first difference data object identifying the at least one template together with the respective differences to be applied to the at least one template that allow the first data object to be reconstructed; the first party sending the first compressed data object to the second party; the second party reconstructing the first data object to form a first reconstructed data object; the second party producing a second data object which comprises or is mapable onto the first reconstructed data object together with respective differences to be applied to the first reconstructed data object; the second party determining the respective differences to be applied to the first reconstructed data object; and the second party forming a second difference data object which identifies the first reconstructed data object together with the respective differences to be applied to the first data object that allow the second data object to be reconstructed.

According to a seventh aspect of one embodiment of the present disclosure, there is provided a method of exchanging information between a first party and a second party, where the first and second parties each possess a copy of at least one template, and the first party possesses a first data object which comprises or is mapable onto the at least one template together with respective differences to be applied to the at least one template, and the method comprises the steps of the first party determining the respective differences to be applied to the at least one template; the first party forming a first difference data object identifying the at least one template together with the respective differences to be applied to the at least one template that allow the first data object to be reconstructed; the first party sending the first difference data object to the second party; the second party reconstructing the first data object to form a reconstructed first data object; the second party producing a second data object which comprises or is mapable onto the first reconstructed data object together with respective differences to be applied to the at least one template; the second party determining the respective differences to be applied to the at least one template; and the second party forming a second difference data object which identifies the at least one template together with the respective differences to be applied to the at least one template that allow the second data object to be reconstructed.

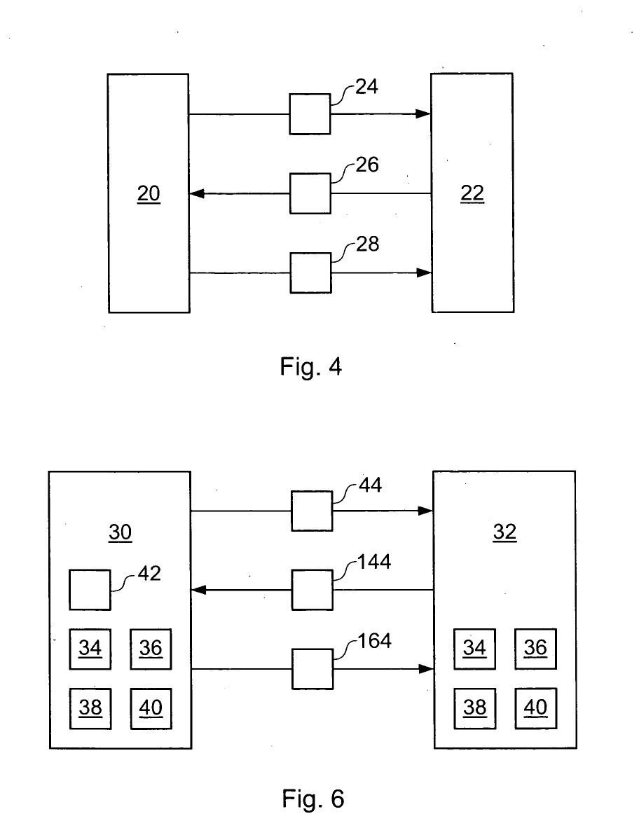

FIG. 4 shows an example prior-art situation where a customer 20 wishes to request product details from a supplier company 22. The customer 20 and supplier 22 exchange a single document and each update the document in order to submit their respective questions and responses.

The customer 20 initially sends an order document 24 (which is based on a blank or template document supplied by the supplier) to the supplier 22. This document contains details of the products in which the customer 20 is interested. The products may be identified by name or part number, both of which have been previously made available to the customer 20 by the supplier 22. The order document 20 may also contain other information. For example, purchase terms and conditions may be included for legal purposes. These terms and conditions may be previously agreed upon between the customer 20 and the supplier 22, or they may be standard terms and conditions asserted by the customer 20 or supplier 22.

Once the supplier 22 has received the order document 24, the supplier 22 examines the document 24 to look for product names or part numbers which it supplies. The supplier updates the information within the order document 24 to produce an updated document 26. The updated document contains updated information on each product requested by the customer 20. For example, the updated information may include product prices, availability, and the like. This eliminates the need for the customer 20 to keep and maintain an up-to-date list of the details of the products of the supplier 22. The supplier 22 may add or delete information in the order document 24 to produce the updated document 26.

The supplier 22 then sends the updated document 26 back to the customer 20 as shown in FIG. 4. The customer 20 then examines the document 26 to determine whether the initial order is to be confirmed, for example whether the total price does not exceed a certain limit. The customer 20 then updates the updated document 26 to produce a confirmatory document 28. The confirmatory document 28 may contain further information such as delivery address, billing details and other information that will indicate to the supplier 22 that the order has been confirmed. The customer 20 sends the confirmatory document 28 to the supplier 22 who will then process the completed order accordingly.

The updated document 26 and confirmatory document 28 contain much or all of the information in the original order document 24. This repeated information may be substantial in size, for example if lengthy terms and conditions are included in the order document 24, and therefore are also included in the subsequent documents 26, 28. Therefore a large amount of redundant information is transmitted between the customer 20 and supplier 22 when transmitting the updated document 26 or confirmatory document 28. The information is redundant because it is already known by the recipient.

FIG. 6 shows an arrangement where a customer 30 and a supplier 32 exchange information using an exchange method constituting an embodiment of the present disclosure. This however is only an example and embodiments of the present disclosure are not limited to the exchange of information between customers and suppliers.

The customer 30 and the supplier 32 are both in possession of a master template 34 and three further templates 36, 38, 40 which are sub-templates of the master template. In an alternative embodiment, a party may have any number of master templates and further templates. The role of the master and further templates will be described in more detail below.

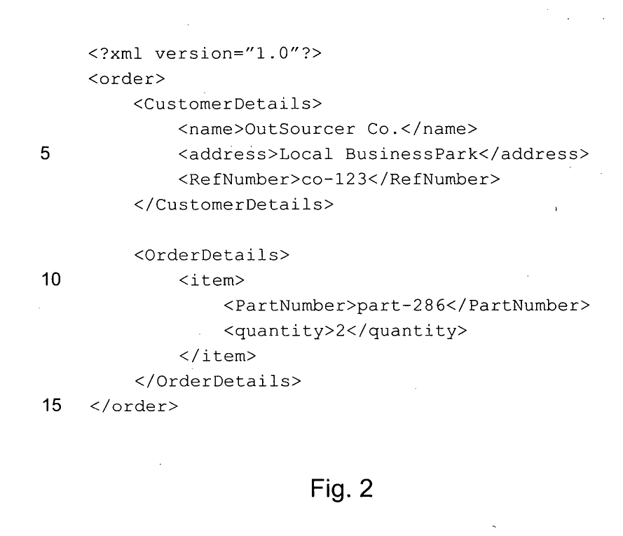

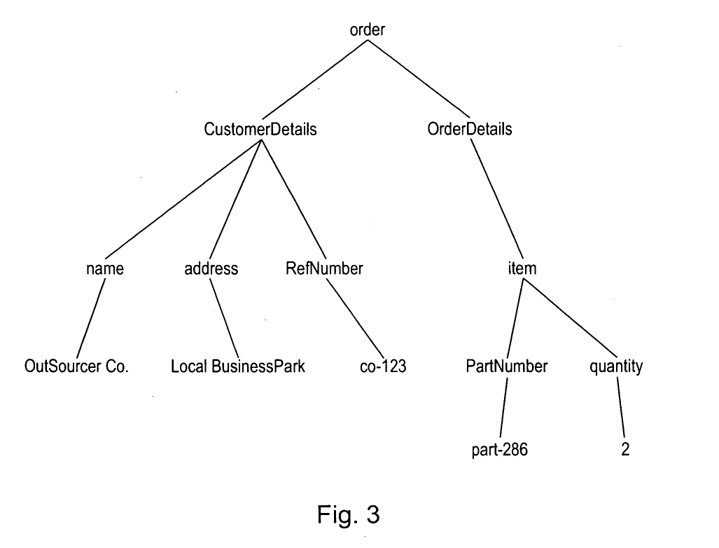

The customer is also in possession of a data object such as an XML order document 42. This document is created by the customer 30 and contains a list of products which the customer wishes to purchase or receive information about from the supplier 32. An example of an XML order document, which constitutes a data object, 42 is shown in FIG. 2. The order document 42 may be created for example by the customer's computer, when a user enters a product request into the computer. The user may be constrained by a form such as a web-based form as is well known to those skilled in the art. Such a form presents predefined fields to the user who may then enter information into those fields. Once the user signals that all of the required information has been entered into the fields, for example by clicking a button, the information can be converted into XML format.

The use of such a form is advantageous because the information entered can only be of an expected type. The user cannot enter a piece of information of an undefined type. However, one embodiment, among others, does not require the use of such a form, and the XML order document 42 may be produced by the customer 30 using an alternative method known to those skilled in the art.

The types of information that may appear within the order document 42 may also be constrained by an XML DTD or schema. The DTD or schema (not shown) would be previously agreed upon between the customer 30 or supplier 32. Alternatively the DTD or schema would be asserted by the supplier 32, as it is advantageous for the supplier 32, who may potentially receive order documents from multiple customers, to be able to control the format of the order documents. The templates 34, 36, 38, 40 are also previously agreed upon between the customer 30 and supplier 32, or asserted by the supplier 32, or indeed by the customer. The templates may be produced based on analysis of previous order documents, in order to produce templates which make subsequent transactions more efficient in terms of the amount of data that must be transmitted, and/or the processing required by the customer 30 or supplier 32. Additionally or alternatively they may be selected due to convenience. The example templates include separate templates for customers details (template 36), item details (template 38) and shipping details (template 40). Such an arrangement may facilitate the retrieval of information from a template, as only the template that contains the required information must be considered.

Instead of sending the full order document 42 to the supplier 32, the customer 30 creates (or computes) and sends a data object that comprises a list of differences to the supplier 32. This list of differences will be known as a diffdoc. The diffdoc 44 is an XML document containing instructions to the supplier 32 on how to modify the master template 34 and subsections indicating how to modify further templates 36, 38, 40 so that together they can be used to regenerate and/or allow the customer's information to be identified in the order document 42. Therefore the diffdoc 44 is a compressed data object representing the order document 42.

The differences in the diffdoc are respective differences between the order document 42 and the templates 34, 36, 38, 40. Each difference is represented by an XML element which identifies an item of data structure and/or data content to be added to, deleted from, or modified in one of the templates 34, 36, 38, 40, in order to produce the same data structure and content within the modified templates as is found in the order document 42. An item of data structure is an XML element. An item of data content could be an attribute, attribute value, text node, or other node which contains data.

Although the templates 34, 36, 38, 40 are separate XML documents, together they form a single XML data structure. This is achieved by including links within the master template 34 which point to further templates 36, 38, 40. One link points to one further template. It is also possible that a further template may contain links to other further templates. Thus the templates are arranged in a hierarchical fashion. The template at the top of the hierarchical tree is the “master” template 34.

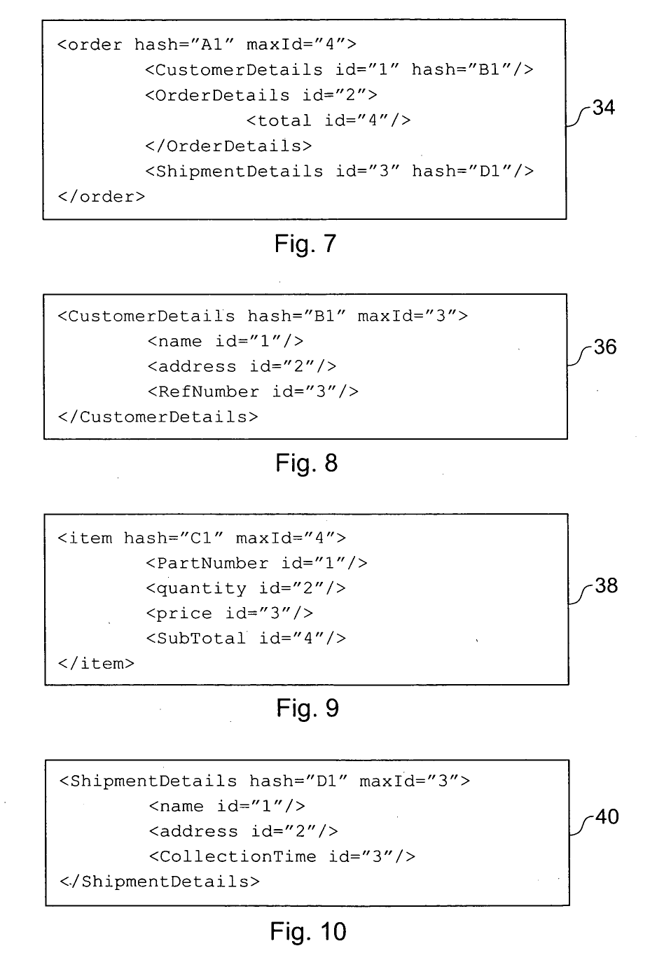

Examples in XML of the master template 34 and additional templates 36, 38, 40 are shown in FIGS. 7 to 10 respectively. The templates 34, 36, 38, 40 are chosen by one or more of the parties involved in the exchange of XML information. For example, they may be previously agreed upon between the customer 30 and supplier 32. Advantageously, they are chosen based on previous transactions such as those described above with reference to FIG. 4. In this way, templates can be chosen that help to minimize the amount of information that must be transmitted between the parties. The parties also agree on (or one imposes on the other) an XML schema which sets out the format for an XML order document.

The root element within each template contains an attribute named “hash” (hereinafter called the hash attribute) and a value which is a hash checksum that has been calculated over that XML template, excluding the checksum itself. For example, the root element of the master template 34 found in line 1 of FIG. 7, is named “order” and contains a hash attribute with the value “A1.” The values given to the hash attributes in the example templates 34, 36, 38, 40 are not actual checksums but are arbitrary values which are used to exemplify the function of the hash values. The function of the hash values is to provide a unique identification for each template. It follows that it must be extremely unlikely for two XML templates or other XML documents to have the same XML checksum. Functions which calculate suitable hash values are well known to those skilled in the art.

Each element within each of the templates 34, 36, 38, 40 (with the exception of the root elements) contains an attribute “id” within its start tag the value which for simplicity, but not necessarily, is an integer. This integer value is unique within a single template. The “id” value can be used to refer to individual elements within a template, and acts as a short identifier in place of the element name or element XPath. XPath is a language for addressing parts of an XML document. The current XML specification (January 2004) is available on the Internet at a web site maintained by the World Wide Web Consortium. In a simple form, XPath can be used to specify individual elements and nodes within an XML document. Such an XPath takes the form A[x]/B[y]/C[z]/ . . . where A, B, C are the names of the element being referred to, and its parents, and x, y, z denote the ordinal position of each element of the specified name among other elements having the same name and the same parent elements. An XPath which refers to an individual element or node shall be referred to herein as the XPath of that element or node.

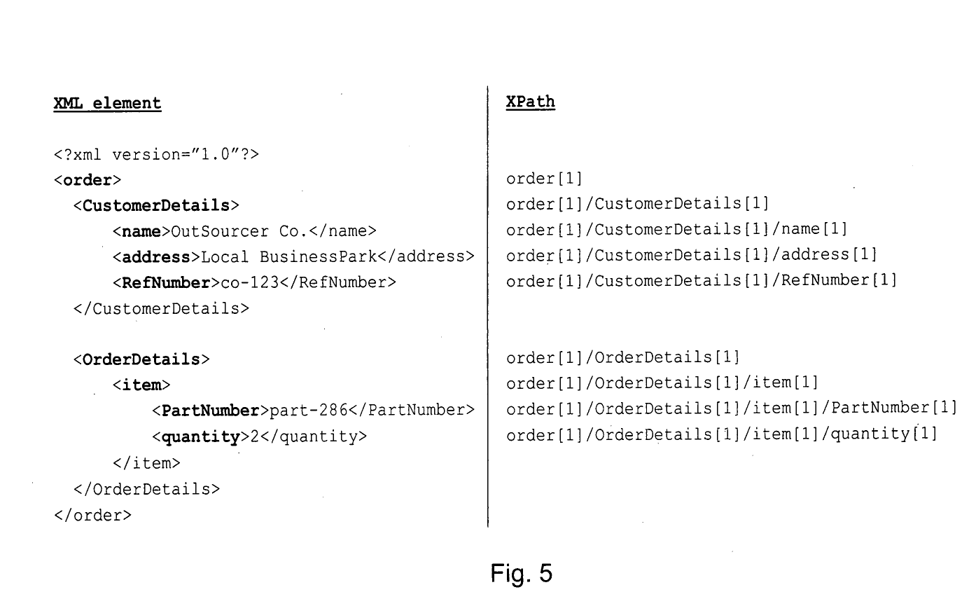

For example, in the order document shown in FIG. 2, the XPath of the RefNumber element in line 6 is order[1]/CustomerDetails[1]/RefNumber[1]. The ordinal positions are all 1 as only one element of a particular name exists having the same parents. FIG. 5 shows the order document of FIG. 2, with an XPath added alongside each element start tag to illustrate the use of XPath to refer to each element. Other nodes such as attributes and text nodes also have individual XPaths, but these are not shown in the example in FIG. 5.

The root element within each template also contains an attribute named “maxId.” This attribute takes a value equal to the maximum “id” attribute value of any element within that template. This is present so that each time this value is needed, the template does not have to be parsed to determine the value. An example of when the “maxID” value is needed is when an element is added to the template, and requires a unique “id” attribute value equal to one higher than the current maximum value. Examples of “maxId” attributes can be found within the root elements of the templates 34, 36, 38, 40 shown in FIGS. 7 to 10.

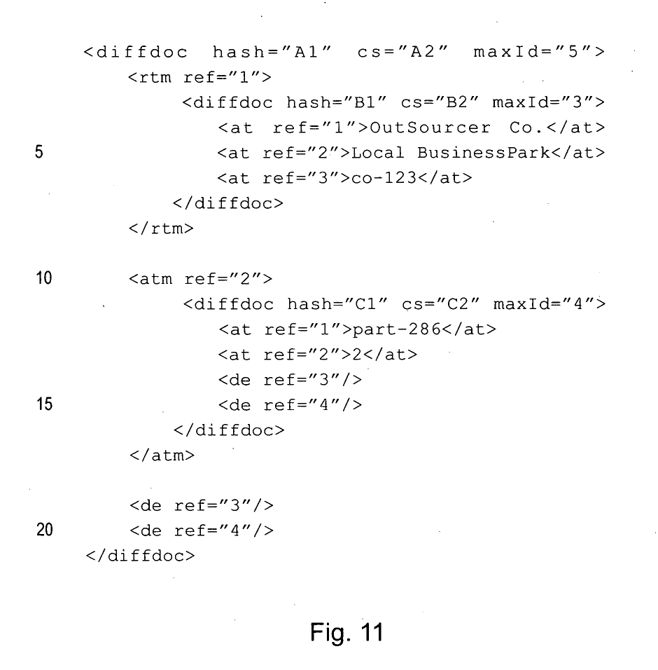

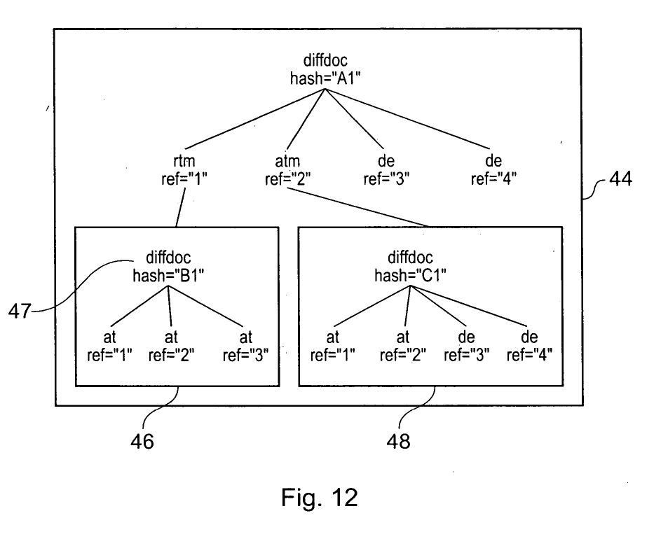

The XML diffdoc 44, which is shown in FIG. 11, is produced by comparing the order document 42 (FIG. 2) with the templates, examples 34, 36, 38 and 40 of which are shown in FIGS. 7 to 10. The XML diffdoc 44 is an XML data structure and can therefore be visualised as a tree-like structure as shown in FIG. 12. Each element name has a relevant attribute and value relating to that element shown beneath it.

The root element of the diffdoc 44 is named “diffdoc” and contains instructions for modifying the templates. The start tag of the “diffdoc” element contains an attribute “hash.” The value of this attribute is equal to the hash attribute value found in the root element of the template to be modified by that diffdoc. Therefore the function of the hash attribute in the diffdoc 44 contrasts with the function of a hash attribute in the root element of a template, which is to provide a checksum of that template.

Each element within the diffdoc 44 (with the exception of the root element) contains an attribute “ref.” The value of this attribute corresponds to the “id” value of the element to which the instruction applies, in the template which is to be modified by that diffdoc.

Diffdocs can be nested, so that a single XML diffdoc can be used to modify more than one template. The example diffdoc 44 contains two nested diffdocs 46 and 47. In FIG. 12, which shows the diffdoc 44 as a tree-like structure, a box is drawn around each diffdoc for clarity. The highest diffdoc 44 in the tree-like structure is called the “top-level” diffdoc.

A nested diffdoc has a “root” element named “diffdoc.” This “root” element is not a true XML root element, as it is a child of the diffdoc element in which it is nested. The “root” element contains a hash attribute with a value equal to the hash attribute of the template to be modified by that nested diffdoc. For example, the nested diffdoc 46, found in lines 3 to 7 of FIG. 11, has a “root” element 47 as shown in FIG. 12. This element contains the hash attribute value “B1,” indicating that the template 36 (shown in FIG. 8) is to be modified by the nested diffdoc 46. Therefore, a diffdoc can comprise a plurality of parts, with each part containing instructions for modifying one of the templates 34, 36, 38, 40. The parts are all contained within a single XML document for convenience when sending the diffdoc 44, although this is not essential.

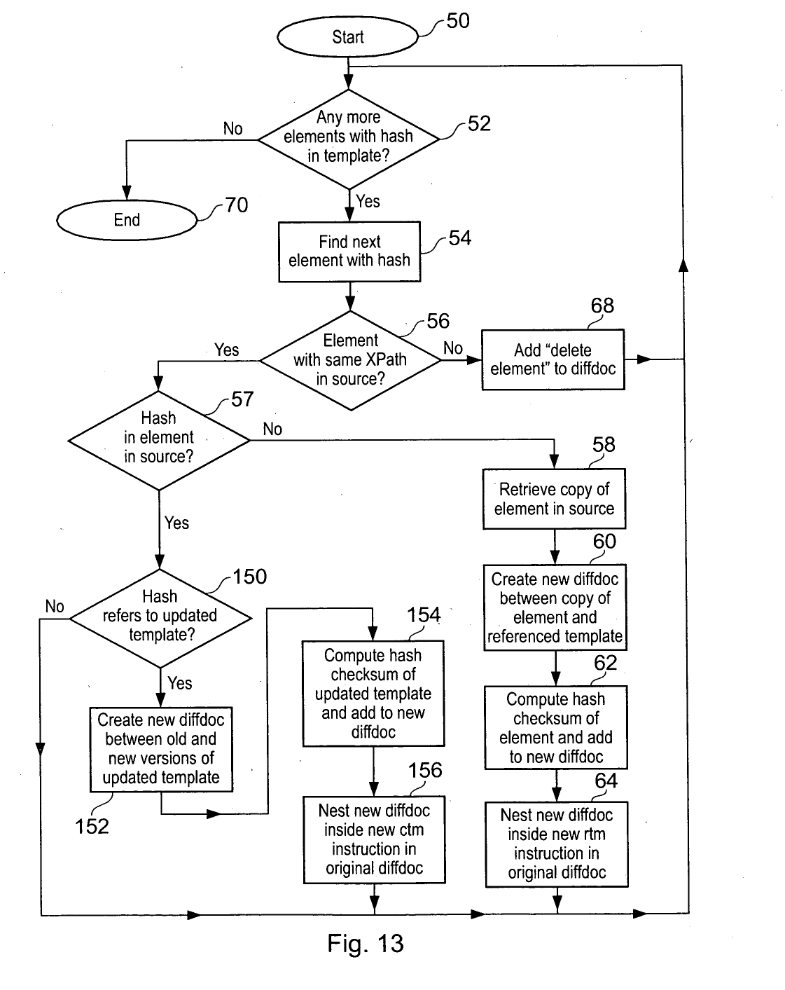

The process used to produce the diffdoc 44 (and any other diffdoc) will now be described with reference to FIGS. 13 to 16. This process is a three-stage process. The process produces a diffdoc from a “source” document, a master template, and one or more further templates. When producing the first diffdoc 44, the source document is the order document 42, the master template is the master template 34 shown in FIG. 7, and the further templates are the further templates 36, 38, 40 shown in FIGS. 8 to 10. Subsequent diffdocs may be produced from different source documents and templates. However, the process will be described as if the first diffdoc 44 is being produced.

The first stage of the process starts at step 50 as shown in FIG. 13. Control then passes to step 52, where it is determined whether there are any further elements within the master template, not including the root element, which contain a hash attribute in the element start tag. In other words, the XML master template is parsed from start to end to look for elements containing a hash value (not including the root element). An example of such an element is found in line 2 of the master template 34 shown in FIG. 7. The hash value within such an element refers to a particular further template 36. This further template referred to may be used to create a further diffdoc as described below.

If at step 52 it is determined that there are further unprocessed elements containing hash attributes, control passes to step 54. At step 54, a copy of the next such element is retrieved from the XML master template 34. Control then passes to step 56, where the source document is searched to determine whether there is an element in the order document 42 with the same XPath as the element retrieved from the master template 34 in step 54.

For example, at step 52 the process may locate the CustomerDetails element in line 2 of the master template 34. This element has a hash attribute. A copy of this element is retrieved in step 54. The element has an XPath of order[1]/CustomerDetails[1], as shown in FIG. 5. Therefore at step 56 the source document (being the order document 42) is searched to find an element with the same XPath. This is found in line 3 of the order document 42, shown in FIG. 2. However, a matching element may not necessarily be present in the source document.

Referring back to FIG. 13, if at step 56 it is determined that there is an element in the source document with the same XPath as the element retrieved from the master template 34 in step 54, then control passes to step 57. At step 57, it is determined whether the element in question in the source contains a hash attribute. If this is not the case, as in the present example (FIG. 2, line 3), then control passes to step 58. An example where this is the case is described later in the description of the present disclosure.

At step 58, a copy of the element in question is retrieved from the source document, including any data and/or child elements within that element. Control then passes from step 58 to step 60 where a new diffdoc is created. This further diffdoc, once created, will contain instructions for modifying the further template 36 referred to in the element found in step 54, to produce the element retrieved from the source document in step 58. The further template referred to is called the referenced template, as the hash in the master template acts as a reference or link to the referenced template. The further diffdoc will be nested inside the diffdoc 44, as shown in FIG. 12.

In the present example, where the element from the master template 34 found in step 54 is the CustomerDetails element in line 2 of FIG. 7, the hash attribute value within this element start tag is “B 1.” Therefore at step 60 a further diffdoc is produced for the differences between the template having a hash “B1,” which is the CustomerDetails template 36 of FIG. 8, and the CustomerDetails element (and its contents) from the order document 42 retrieved at step 58, as described above. The further diffdoc is produced using the full three-stage process, and is shown in lines 3 to 7 of FIG. 11, and indicated by the reference numeral 46 in FIG. 12. This further diffdoc is included as a nested diffdoc 46 in the top-level diffdoc 44, as described below. Thus the process for creating diffdocs can be recursive. The top-level diffdoc is the diffdoc that contains instructions to be applied to the master template 34, and also contains all further diffdocs. Thus, diffdocs can be nested and further diffdocs may themselves contain further diffdocs within them. When creating a nested diffdoc using the three-stage process, the referenced template is called the master template, and the retrieved element is called the source document.

It should be noted that, within the nested diffdoc as shown in lines 3 to 7 of FIG. 11, the start tag of the diffdoc element in line 3 includes the hash “B 1” to specify that the instructions contained within that nested diffdoc should be applied to the CustomerDetails template 36 which has the same hash value. The start tag also contains a “cs” attribute with the value “B2.” The value “B2” is the hash checksum of the CustomerDetails element retrieved from the order document 42 in step 58 above. This checksum is calculated and added to the start tag as the “cs” attribute at step 62, which follows on from step 60. The checksum can later be used by the supplier 32 to verify that changes to the CustomerDetails template 36 have been applied correctly. When the hash checksum of the element from the order document 42 has been calculated and added as a “cs” attribute to the further diffdoc in step 62, control passes to step 64 where the further diffdoc is added to the top-level diffdoc 42.

In this step 64, a “rtm” instruction element is added to the top-level diffdoc. The “rtm” instruction is an XML element which refers to an element within a template 34, 36, 38, 40. The instruction replaces the element referred to with an element which is a pointer to another document. An example of a “rtm” instruction element is shown in FIG. 11 in lines 2 to 8. Also, in this step 64, the further diffdoc created in step 60 is added to the top level diffdoc 44 as a child of the “rtm” instruction element. The “rtm” element start tag contains a “ref” attribute. The value of this attribute corresponds to the value of the “id” attribute of the element which is to be replaced. The template containing the element to be replaced is the template referenced by the hash value in the start tag of the diffdoc element which is the immediate parent of the “rtm” instruction. The immediate parent of the “rtm” instruction in line 2 of FIG. 11 is the top-level diffdoc element having a start tag in line 1. The start tag contains the hash “A1.” Therefore this “rtm” instruction refers to the CustomerDetails element with an “id” value of 1 in the master template 34.

The example “rtm” instruction, when carried out, replaces the CustomerDetails element referred to in the master template 34 with another empty CustomerDetails element. The replacement element start tag (which is an empty element tag) includes a hash attribute having a value equal to the hash checksum of the further template 36, after it has been modified by the further diffdoc 46. In general, a “rtm” instruction element contains a diffdoc for modifying a template. This template then assumes a new hash value. This hash value is included in the replaced element. Therefore the replaced element acts as a link to the modified template, and replaces a link to the unmodified template.

The hash value in the above example can therefore be used for three purposes: (1) as a link in the modified master template to the modified further template; (2) as a checksum to check that the instructions in the diffdoc have been applied correctly; and (3) as a reference to the modified template, so that it may be used as a template by a later diffdoc.

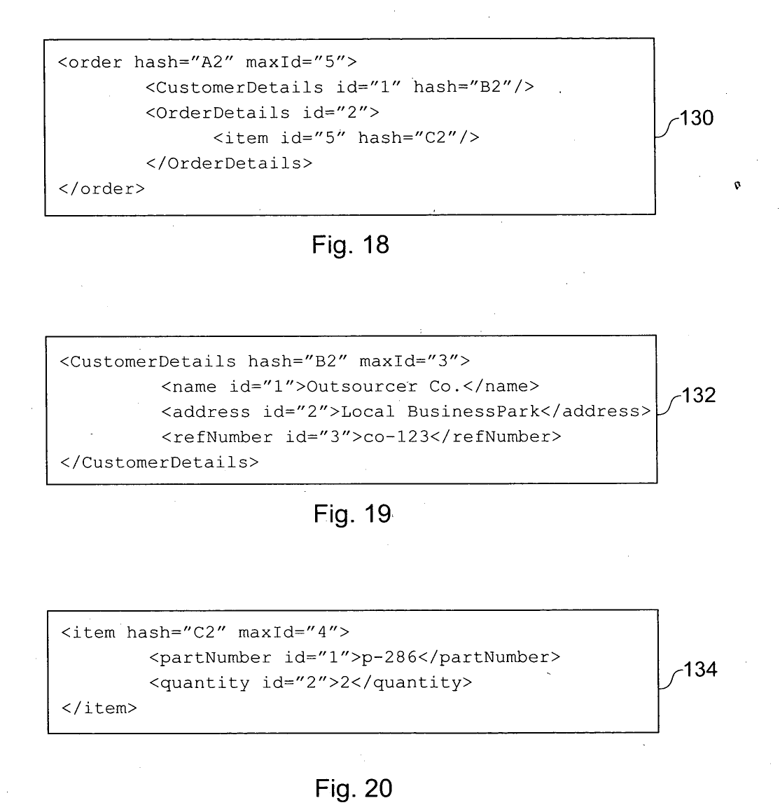

The “id” attribute and value from the replaced element start tag is given to the replacement element in the master template 34. The replacement element can be found in line 2 of FIG. 18. This figure shows the updated master template once the instructions in the completed diffdoc 44 (FIGS. 11 and 12) have been applied to it. Returning to FIG. 13, once the “rtm” instruction element has been added to the master template 34 with the further diffdoc added as a child of the instruction element in step 64, control passes back to step 52.

If it is determined at step 56 that there is not an element in the source document with the same XPath as the element found in the master template 34 in step 54, then an instruction must be added to the diffdoc 44 to delete this element from the master template 34, so that the template when modified does not contain any elements not present in the source document 42. Therefore control passes from step 56 to step 68. At step 68, a delete element instruction is added to the diffdoc 44. The delete element instruction takes the form of an empty element with the name “de” and has a “ref” attribute equal to the “id” of the element to be deleted from the master template 34. The element to be deleted is the element found at step 54. Control then passes from step 68 back to step 52. If it is determined at step 52 that there are no more elements within the master template with a hash attribute, then control passes from step 52 to step 70 where the first stage of the process of creating the diffdoc ends.

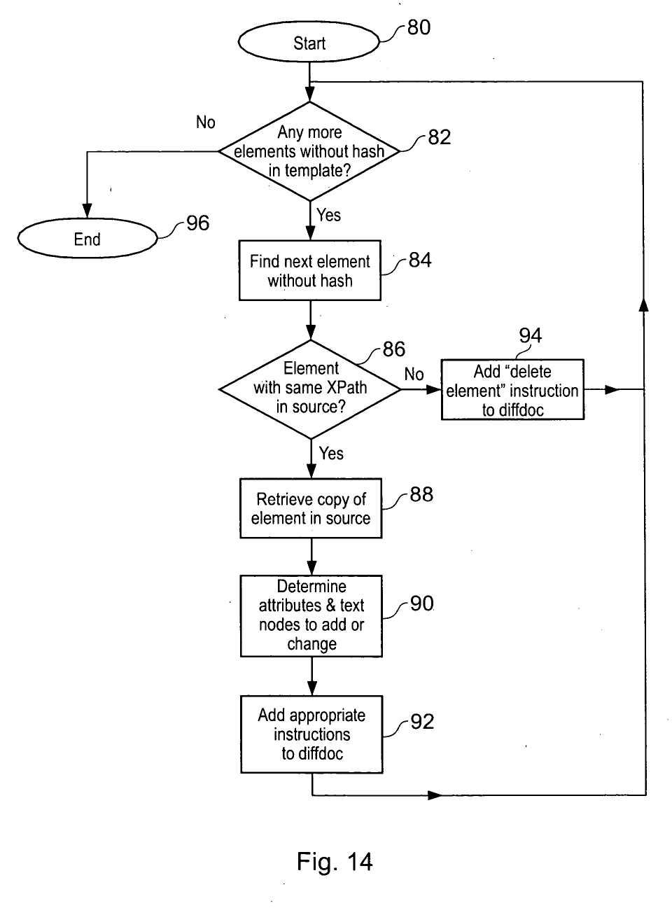

The second stage of the process for producing the diffdoc 44 is shown in FIG. 14. The second stage starts at step 80, from which control passes to step 82. At step 82, it is determined whether there are any elements in the master template 34 which do not have a hash attribute in the start tag. If there are any elements, then control passes to step 84 where the next such element is found, starting from the first element in the master template 34. In other words, the master template 34 is parsed from start to end to look for elements without a hash.

Control then passes from step 84 to step 86. At step 86 it is determined whether there is an element in the source document without a hash and having the same XPath as the element in the master template 34 found at step 84. If there is such an element then control passes from step 86 to step 88. At step 88, the element in the source file with the same XPath is retrieved, along with its contents. Control then passes from step 88 to step 90. At step 90, it is determined whether attributes and text nodes within the element in the template need to be added, deleted, or changed to form the element in the source document retrieved at step 88.

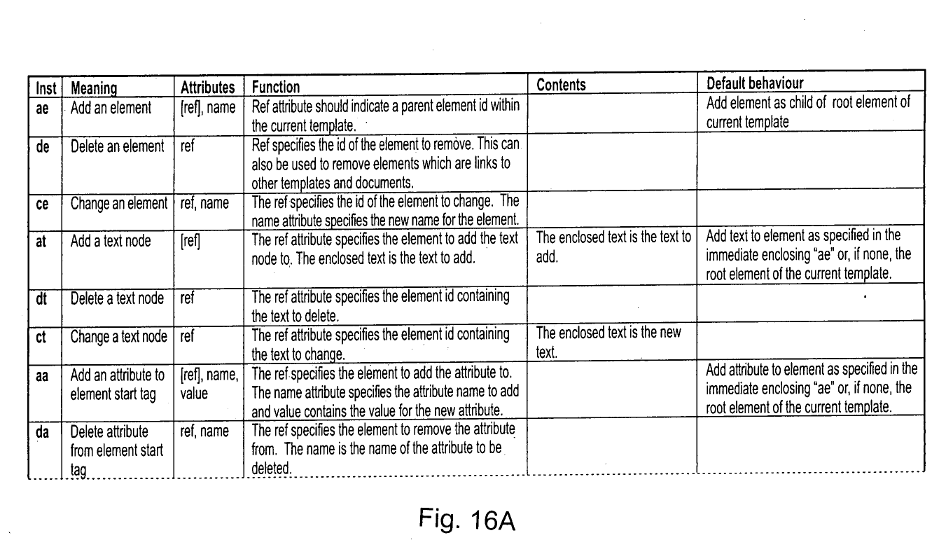

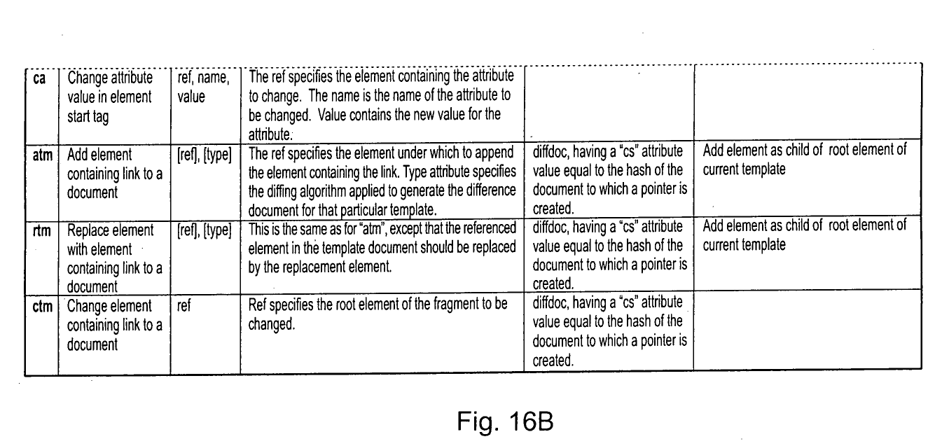

Control then passes from step 90 to step 92 where the appropriate instruction elements are added to the diffdoc. These instructions comprise “aa,” “ca,” “da,” “at” and “ct” along with appropriate arguments. FIGS. 16A-16B show a list of instruction elements available to be added to a diffdoc. The “inst” column lists the name given to each instruction element. The “meaning” column gives a brief description of the function of each instruction. The “attributes” column lists names of attributes that may be present in the instruction element. Attribute names in square brackets are optional. Otherwise, the attributes must be present where the instruction is used. The “function” column gives an explanation of the purpose of each attribute associated with that instruction. The “contents” column lists expected contents of each instruction element (i.e. what is present between the start and end tags). The “default behaviour” column gives default behaviour of the instruction, if an optional “ref” attribute is not present in the instruction when used.

The start tag of each instruction element contains an attribute “ref” with a value equal to the “id” of the element in the master template 34 to which the instruction applies. All instruction elements contain a “ref” attribute and value, although some instructions can omit this attribute to follow the default behaviour, as indicated in FIGS. 16A-16B.

For an example of an instruction element, consider the further diffdoc 46 which is found in lines 3 to 7 of FIG. 11. When this further diffdoc is being created, the “B1” template (which is the CustomerDetails template 36) is taken to be the “master” template, and the CustomerDetails element found in lines 3 to 7 of FIG. 2 is taken to be the “source document.” Stage two of the process of creating the further diffdoc 46 finds, for example, in step 90 of FIG. 14, that a text node needs to be added to the “name” element in the template 36 (shown in line 2 of FIG. 8) to produce the “name” element with the same XPath in the “source” document (this element is shown in line 4 of FIG. 2). Therefore an “at” instruction is added to the further diffdoc 46 in step 92.

The “id” of the element in the template 36 is 1. Therefore the “at” instruction contains the “ref” value “1” to indicate the correct element to which a text node should be added. The text to add is included as the contents of the “at” instruction element (see FIGS. 16A-16B for correct usage of this and other instructions). Therefore an appropriate instruction is added to the further diffdoc 46, and can be found in line 4 of FIG. 11.

If it is determined at step 86 in FIG. 14 that the element without a hash in the template found at step 84 does not have an equivalent in the source document with the same XPath, then control passes from step 86 to step 94. At step 94, a “de” instruction element is added to the diffdoc to delete the element in the template. For example, the ShipmentDetails element in line 6 of the master template 34 of FIG. 7 does not have a corresponding element with the same XPath in the source order document of FIG. 2. This element in the template has the “id” value “3.” Therefore a “de” instruction element is added as a child to the diffdoc 44 for the master template 34. This instruction element can be found in line 19 of the diffdoc 44 shown in FIG. 11. The instruction element contains the “ref” value “3” indicating the “id” of the element to be deleted.

Also, the “total” element in line 4 of the master template 34 does not have a corresponding element in the source. Therefore an instruction is added to the diffdoc to delete this element. The instruction is found in line 20 of the diffdoc 44 in FIG. 11. It should be noted that this instruction element is added as a child of the diffdoc element, as is the instruction to delete the ShipmentDetails element in line 19. However the two elements to be deleted are at different levels of the hierarchy of the structure of the master template 34. Therefore the position in the hierarchy of the element to be deleted does not affect the position in the diffdoc hierarchy of the “de” instruction element. This is true for all other instructions in a diffdoc, except for instructions contained within a nested further diffdoc. Referring back to FIG. 14, once the “de” instruction has been added to the diffdoc in step 94, control passes back to step 82.

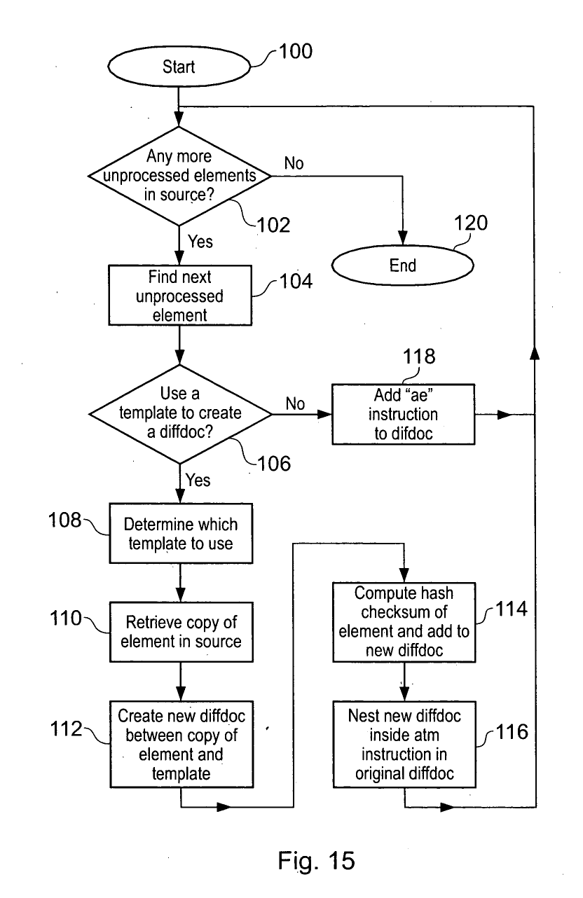

If it is determined in step 82 that there are no more unprocessed elements without a hash in the master template 34, then control passes from step 82 to step 96 where the second stage of the process for creating the diffdoc 44 ends. The third stage of the process is shown in FIG. 15 and starts at step 100. From step 100, control passes to step 102. At step 102, it is determined whether there are any elements within the source document that have not been processed in the first or second stages, shown in FIGS. 13 and 14 respectively. If it is determined that there are such elements, then control passes to step 104 where the next such element is found, starting from the top of the source document. In other words, the source document is parsed from start to end to look for unprocessed elements. Unprocessed elements will be elements which do not have an equivalent element with the same XPath within the master template 34 and linked further templates.

From step 104, control passes to step 106 where it is determined whether a diffdoc should be created between the element found in step 104 (and its contents), and a further template. This is determined by examining a template table (not shown) which contains a list of XPaths and associated templates. This template table may be predetermined between the customer 30 and supplier 32 within an XML schema as described earlier in the description. The template table may also be located elsewhere, as will be obvious to a person skilled in the art.

For example, the template table may specify that the “item” element found in lines 10 to 13 of FIG. 2, which has the XPath order[1]/OrderDetails[1]/item[1] as shown in FIG. 5, should be associated with the item template 38 shown in FIG. 9. Ordinal positions of the elements are ignored so that all item elements with correct parents are associated with the item template, and not just the item element at a particular ordinal position.

Referring back to FIG. 15, if it is determined at step 106 that the element found in step 104 is associated with a further template, then control passes to step 108 where it is determined which template should be used. This is done by looking up the element XPath in the template table and finding the associated hash value, which refers to a particular template.

Control then passes to step 110. At step 110, a copy of the element found in step 104 is retrieved from the source document, along with the element's contents. From step 110, control passes to step 112 where a new further diffdoc is created between the element retrieved in step 110 and the further template determined at step 108, using the full three-stage process. When creating the further diffdoc, the “source” document is the copy of the element retrieved at step 110, and the “master” template is the template determined at step 108.

For example, the “item” element in lines 10 to 13 of the source document in FIG. 2 would be found at step 104. At step 106, it would be determined that the element should be associated with a template, i.e. there is an appropriate XPath in the template table. At step 108, it would be determined that the item template of FIG. 9 should be used. At step 110, a copy of the item element and contents (lines 10 to 13 of FIG. 2) would be retrieved. At step 112, a further diffdoc 48 between the item element and item template would be created. This further diffdoc is found in lines 11 to 16 of the top-level diffdoc 44, shown in FIG. 11.

This further diffdoc 48 contains instructions to modify the item template 38 so that it contains the same data as the item element from the source document (being the order document 42 shown in FIG. 2). The “root” element start tag of the further diffdoc 47 (which is not a true root element) is found in line 11 of FIG. 11. This start tag contains the hash value “C 1” which is the hash value of the item template 39. The start tag also contains the “cs” checksum value “C2” which is the checksum of the item element retrieved from the order document 42, and can be used later to check whether the instructions in the further diffdoc 48 have been correctly applied to the item template 38.

Once the further diffdoc has been created in step 112 of FIG. 15, control passes to step 114 where the hash value of the element retrieved in step 110 is calculated and added as the “cs” attribute in the “root” element of the further diffdoc created in step 112.

Control then passes from step 114 to step 116, where the further diffdoc is nested inside the top-level diffdoc 44 inside an “atm” instruction element. An example of such an instruction element is found in line 10 of FIG. 11. The instruction, when applied, adds a link to the master template 34 which points to the further template modified by the further diffdoc created in step 112. For example, the link may contain the hash value “C2” which refers to the item template 38 after it has been modified by the further diffdoc 48.

The “atm” instruction element contains a “ref” attribute, with a value equal to the “Id” of an element within the master template 34. The instruction adds an empty element as a child of this element within the master template 34, the empty element being a link to the modified further template. For example, the “atm” instruction in line 10 of FIG. 11 adds a link point to the modified item template (which is modified by the further diffdoc 48 being the child of the instruction element) to the element in the master template 34 with an “id” value of 2. This element is the OrderDetails element found in line 3 of FIG. 7. This is consistent with the original order document 42 of FIG. 2, where the OrderDetails element in line 9 has an “item” element as a child (found in lines 10 to 13).

It should be noted that the “atm” instruction and nested further diffdoc are not necessarily added as an immediate child of the root element of the top-level diffdoc 44 in step 116 as shown in FIG. 15. It is possible that they will be added as a child of another nested further diffdoc. This is true whenever a further diffdoc is added at any stage of the three-stage process. An example where this would occur is when a first element within the source document is associated with a first template, which results in a first further diffdoc within the top-level diffdoc 44, and a second element within the first element is associated with a second template. A second further diffdoc will be generated and nested within the first further diffdoc.

Referring back to FIG. 15, once the “atm” instruction and further diffdoc have been added to the top-level diffdoc in step 116, control then passes back to step 102. Thus, all of the unprocessed elements in the source document are processed in the third stage of creating the diffdoc 44. If at step 106 it is not determined that the element found at step 104 is associated with a template, then control passes from step 106 to step 118.

At step 118, an “ae” instruction is added to the diffdoc. This instruction when carried out adds an element to the master template 34 corresponding to the element from the source document found at step 104. The usage of the “ae” instruction is detailed in FIGS. 16A-16B. The instruction element may contain an “at” instruction element as a child. This “at” instruction can omit the “ref” attribute, in which case it adds a text node to the element added by the “ae” instruction. The “ae” element may also contain an “aa” instruction which may also omit the “ref” attribute in the same way.

Referring back to FIG. 15, once the “ae” instruction has been added to the diffdoc in step 128, control passes back to step 102. If at step 102 it is determined that there are no elements within the source document that have not been processed in any of the three stages, then control passes to step 120 where the third stage ends. Thus the three-stage process ends and the diffdoc 44 is complete.

Once the diffdoc 44 has been created, it is sent from the customer 30 to the supplier 32 as shown in FIG. 6. The supplier 32 then applies the instructions within the diffdoc 44 to the master template 34, and any of the further templates 36, 38, 40 which are referenced by nested further diffdocs within the diffdoc 44. The example diffdoc 44 as shown in FIG. 11 contains two further diffdocs 46, 48 as shown in FIG. 12. The supplier 32 applies each instruction in the diffdoc 44 to the template indicated by the hash attribute value in the diffdoc element which is the immediate parent of that instruction element. The further diffdocs 46, 48 each relate to templates with the hash “B1” and “C1” respectively, so templates 36 and 38 are also modified by the diffdoc 34. The supplier starts with the instruction element at the top of the diffdoc 44 and works downwards.

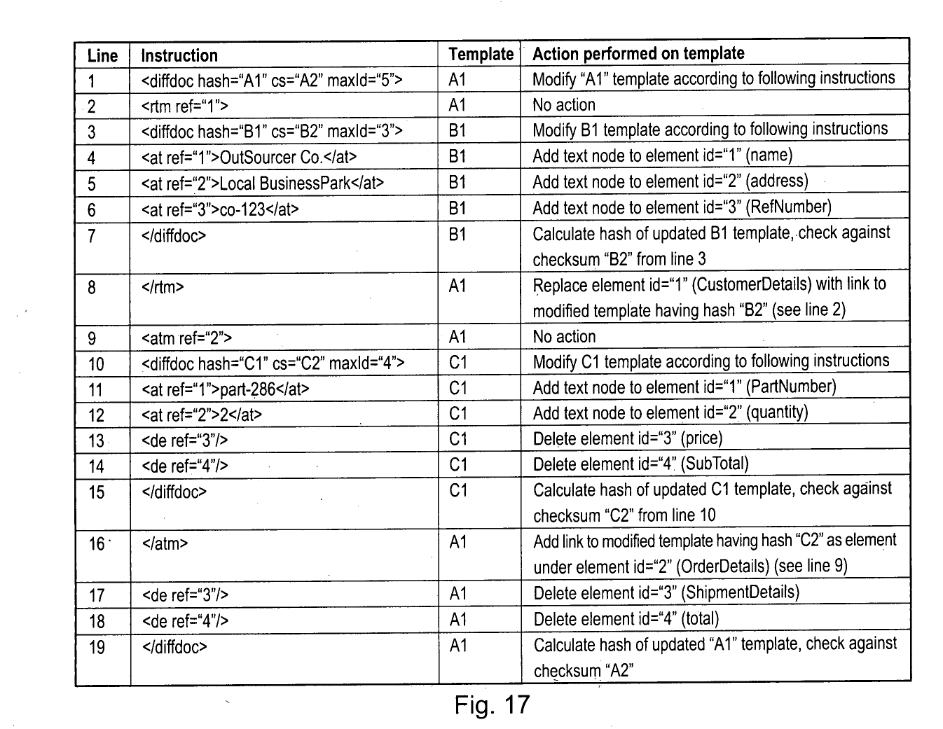

FIG. 17 shows a table containing each line of the diffdoc 44 of FIG. 11, in an “instruction” column. The line number is given in a “line” column. The “template” column shows the hash value of the template 34, 36, 38, 40 to which the instruction in that line of the diffdoc 44 applies. The “action” column provides a brief explanation of the action taken by the supplier 32 when each line of the diffdoc 44 is encountered. Each line is processed in turn from the top of the diffdoc 44 to the bottom. A number of the actions shown in FIG. 17 will now be expanded below.

Lines 1, 3 and 10 each contain the start tag of a new diffdoc. The diffdocs which start in lines 3 and 10 are children of the diffdoc which starts in line 1. Each start tag contains a hash attribute with a value equal to that of the template to which the diffdoc applies. Therefore when one of these lines is encountered, the supplier 32 knows that any following instructions should be applied to the template indicated in the most recently encountered diffdoc start tag, until a diffdoc end tag or another (child) diffdoc start tag is encountered.

If the end tag of a diffdoc is encountered, the supplier 32 knows that any subsequent instructions should be applied to the template which was the focus of interest before the most recently encountered diffdoc start tag. Examples of a diffdoc end tag can be found in lines 7, 15 and 19 of FIG. 17.

When such an end tag is encountered, a hash value for the modified template to which that diffdoc applies is calculated. This value should be equal to the checksum value found in the “cs” attribute in the start tag of that diffdoc. Thus the supplier 32 can verify that the instructions in that diffdoc have been applied to that template correctly.

This checksum value is then added as the “hash” attribute value to the root element of the modified template. This is so that a link to that modified template can be added to another template using the hash value to refer to the modified template. Further diffdocs are always nested within instructions which add or modify links, and the document linked to is that produced by the further diffdoc.

For example, line 2 in FIG. 17 contains a “rtm” instruction which replaces the element having the “id” value “1” in the template having the hash “A1” (which is the master template 34) with a link, which points to a document produced by the diffdoc which is a child of that “rtm” element. This child diffdoc is found in lines 3 to 7 and applies to the template with the hash “B1” (further template 36). The replacement element containing the link is preferably not added to the master template 34 until the document produced by the child diffdoc has actually been created, and the hash checksum is calculated and verified. Therefore, the element containing the link is added to the master template 34 when the end tag for that element is encountered in line 8, after the relevant template has been modified by the child diffdoc and verified. The verification is performed when the diffdoc end tag is encountered in line 7.

In an alternative embodiment, the link could be added just after the “rtm” start tag is encountered in line 2, when the diffdoc start tag is encountered in line 3. This is because the hash value for referencing the modified further template can be found within the diffdoc start tag as a “cs” attribute. Therefore the link is added before the modified further template is modified and verified.

When an instruction adds a new element to a template, the new element is given an “id” value one greater than the current “maxId” value in the start tag of the root element of that template. In this way the highest “id” value can be tracked. When new elements are added to a template, the “id” value is determined by examining the current “maxId” value and adding 1. This avoids the need to parse the entire template to determine the maximum “id” value, and saves processing time. Instructions which add elements are the “atm” and “ae” instructions (see FIGS. 16A-16B). The “maxId” value is incremented as appropriate to keep track of the current maximum “id” value within that template.

Instructions which replace elements give the replacement element the “id” of the element being replaced. Instructions which delete elements discard the “id” of the deleted element. The “maxId” value of a template is not altered when these instructions are encountered. If an element is deleted with an “id” somewhere in the middle of the range of “id” values within that template, the remaining “id” values remain unchanged. There is then effectively a “hole” in the values within that template. When a new element is added, it is given an “id” one greater than the “maxId” value, and does not fill the hole. This provides the most efficient process for determining the new unique “id” value, as the template need not be parsed to look for such holes.

In an alternative embodiment, the “maxId” attributes may be omitted, and/or the “id” holes may be filled when adding new elements. These features require extra processing.

Once the supplier 32 has applied all of the instructions within the diffdoc 44, and updated the hash and maxId attribute values appropriately, the supplier 32 will be in possession of updated master template 130, updated CustomerDetails template 132, and updated item template 134, as shown in FIGS. 18 to 20 respectively. The supplier 32 retains unmodified copies of the original templates 34, 36, 38, 40. The modified templates 130, 132, 134 contain all of the data from the XML order document 42, and the same structure, even though the data and structure are distributed over multiple XML documents 130, 132, 134. Thus, the reconstructed order document comprises a plurality of parts, each part being one of the modified templates 130, 132, 134. The structure is the same provided that any modified further template is linked to through the modified master template, and also any other modified further template if appropriate.

In an alternative embodiment, the supplier 32 recreates the original order document 42 from the modified templates 130, 132, 134 by replacing links to templates with data within the templates. The recreated document may not look identical to the original, but would contain the same structure and data. However, in the described examples of the present disclosure, the original data structure is not recreated. This may be advantageous as described earlier, as different categories of information (e.g. item details, shipping details) are held in different XML documents.

Once the supplier 32 is in possession of all of the information found in the order document 42, the supplier updates the templates with further information. The templates which may be updated are those which have been updated by the diffdoc 44, and those which were not updated. In the present example, templates 34, 36, 38 have been updated to templates 130, 132, 134 respectively, and template 40 remains unchanged. Therefore the supplier 32 may choose to update one or more of the templates 40, 130, 132, 134.

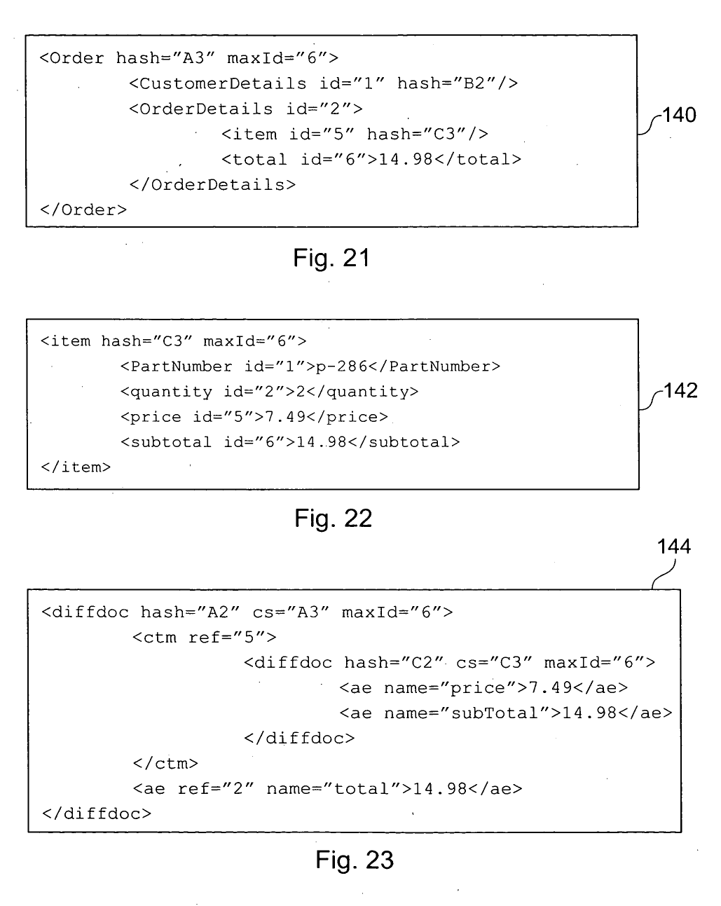

In the present example, the supplier 32 examines the information and updates the price details of the products found within the order document 42 (which the supplier possesses as separate modified templates 130, 132, 134). The supplier 32 also adds subtotals and totals as appropriate. The supplier 32 is limited by the rules laid out in the XML order document schema previously agreed upon with the customer 30. FIG. 21 shows a master template 140 which the supplier has updated from the modified master template 130 by adding a “total” element in line 5, as a child of the “OrderDetails” element. The “total” element was present in the original master template 34 (shown in FIG. 7) but was deleted by the diffdoc 44 as the customer 30 did not include this element within the original order document 42.

The supplier 32 also adds a “price” element to the modified further template 134, and a “subtotal” element, to form an updated item template 142 as shown in FIG. 22. The “price” element contains the price of the supplier's product having the part number indicated by the “Part Number” element in the modified item template 134. The “subtotal” element contains the price value multiplied by the value found in the “quantity” element in the modified template 134. The elements added to the modified template 134 can be found in lines 4 and 5 of the updated template 142.

Once the appropriate elements have been added to the updated templates 140, 142, the hash values in the root elements of those templates are updated. One embodiment of the method used is that described earlier in this description. The elements in the templates which link to templates which have been updated must also be updated with the hash value of the linked template. The hash values of these templates must also be updated and so on.

For example, the hash value of the updated item template 142 is “C3,” and this value is added as the hash attribute value in the root element. Accordingly the element in the updated master template 140 is updated to link to the new version of the item template. Therefore the “item” element in line 4 of the updated master template 140 is amended to link to the template having the hash “C3.”

The hash value of the updated master template 140 is also updated to “A3” to reflect the added “total” element and the updated “item” link. It is therefore necessary to update the hash in any linked documents before the hash of the document containing the link is updated, so that the document containing the link contains the correct hash. It also follows that a template may need to be updated, if only to update any links it contains, even though the information within that template remains unchanged.

Once the supplier 32 has updated the appropriate templates, the supplier 32 produces a second diffdoc 144 which contains instructions to modify the templates 40, 130, 132, 134, such that these templates when modified contain the same information as the updated templates 140, 142 and non-updated templates 40, 132. In practice the diffdoc only contains instructions to update templates 130, 134 to form templates 140, 142 respectively. However, in other situations, it may be possible that the second diffdoc 144 contains instructions to update only links with certain templates, and not the content.

This diffdoc 144 is shown in FIG. 23. The root element contains the hash value “A2” indicating that the modified master template 130 of FIG. 18 should be updated. The root element also contains the “cs” value indicating that the updated master template should have the hash checksum “A3” when updated, this hash being that of the updated master template 140 of FIG. 21 held by the supplier 32.

The second diffdoc 144 is created using the 3-stage process as described above for producing the first diffdoc 44. When producing the second diffdoc 144, the “source” document is the updated master template 140 along with any linked documents, namely the templates 134, 142. The “master template” is the modified master template 130 before being updated. In general, the source document is the most recent version of the master template along with linked templates, or the original order document 42, if there are no versions of the master template beyond the original template 34. The master template is, in general, the version of the master template immediately preceding the most recent version, or the original template 34, if the source is the order document 42.

One difference between the process for producing the diffdocs 44, 144 is that when producing the second diffdoc 144, during the first stage of the process as shown in FIG. 13, an element in the source containing a hash causes control of the process to pass from step 57 to step 150. This does not occur when producing the first diffdoc 44, as the source, which is the order document 42, does not contain any hash values.

An example of such an element is found in line 2 of the updated master template 140, which is the source document. There is an element with the same XPath in the master template 130. Therefore, control in the first stage passes from step 52 through steps 54, 56 and 57 to step 150.

At step 150, it is determined whether the hash in the element found in step 56 refers to a template which has just been updated by the supplier 32. The element in line 2 of the “source” template 140 contains the hash “B2,” which refers to the CustomerDetails template 130. This template has not been updated by the supplier 32. This can be determined by examining the hash values within the corresponding elements between the source 140 and master template 130. If the values are identical then the template has not been updated. Control in this case passes from step 150 back to step 52.

A second example can be found in line 4 of the source document 140. This line contains an element with a hash value of “C3.” The element is therefore a link to the updated item template 142. An element with the same XPath is found in line 4 of the master template 130. This element contains the hash value “C2.” Therefore it is determined at step 150 that the hash in the source refers to a template which has just been updated by the supplier 32. Control therefore passes from step 150 to step 152.

At step 152, a further diffdoc is produced detailing the differences between the old and new versions of the template referred to by the hash value found in the element in question in the source. The “old” version is the most recent version of the template possessed by the supplier 32 before it has been updated by the supplier 32. Therefore, a further diffdoc is produced in the present example between the updated item template 142 and the modified item template 134.

This further diffdoc can be found in lines 3 to 6 of the diffdoc 144, as shown in FIG. 23. The root element of this further diffdoc contains the hash value of “C2” indicating that the item template 134 should be modified. It also contains the “cs” checksum value “C3,” which is equal to the hash of the updated item template 142, so that any party applying the changes in the diffdoc may check that the item template has been updated correctly.

Once the further diffdoc has been created in step 152 as shown in FIG. 13, control passes to step 154 where the hash checksum of the updated template is calculated, and added to the “root” element of the further diffdoc as a “cs” attribute value. This is already shown in the example by the further diffdoc in lines 3 to 6 of FIG. 23.

From step 154, control passes to step 156 where the further diffdoc created in steps 152 and 154 is added to the diffdoc 156 as a child of a new “ctm” instruction element. The “ctm” instruction element start tag is shown in line 2 of the diffdoc 144. The end tag is found in line 7. The start tag contains a “ref” attribute value of “5,” indicating that the element in the master template having an “id” value of 5 contains a link which should be updated. In this element to be updated, the hash value should be updated to link to the updated template produced by the further diffdoc contained within the “ctm” instruction element. Thus the “ctm” instruction and child further diffdoc contain instructions to update the item template 134 to produce the updated item template 142, and update the link in the master template 130 to link to the updated item template 142 instead of the old version 134. Once the further diffdoc has been added to the diffdoc 144 in step 156, control then passes back to step 52. Thus the complete diffdoc 144 is produced.

The further diffdoc found in lines 3 to 6 of FIG. 23, once completed, contains two “ae” instruction elements (in lines 4 and 5 of the diffdoc 144) to add to the item template 134 the two elements in lines 4 and 5 of the updated item template 142, which were added by the supplier 32. The diffdoc 144 contains an instruction to update the link in the master template 130, found in line 2 of the diffdoc 144, and an instruction to add an element, found in line 8. The element to add is the “total” element found in line 5 of the updated master template 140 which was added by the supplier 32.

Once created, the diffdoc 144 is sent from the supplier 32 to the customer 30, as shown in FIG. 6. The customer 30 then carries out the instructions in the diffdoc 144 and produces the updated master template 140 and updated item template 142. Thus, both the customer 30 and supplier 32 are in possession of the most recent versions of all of the templates, which are templates 140, 132, 142, 40 corresponding to the order, CustomerDetails, item, and ShipmentDetails templates respectively.

It is worth noting at this point that in an alternative embodiment both parties may be in possession of more than one of a particular template, which are all up-to-date versions—for example more than one item template corresponding to more than one item in the original order document 42. There would, therefore, be multiple links in one or more templates which link to the multiple item templates.

Once the customer 30 is in possession of all of the up-to-date information within the templates 140, 132, 142, 40, the customer 30 can examine the information to determine the next course of action. For example, the customer 30 may examine the value of the “total” element in the updated master template 140, which shows total transaction cost, and determine whether this value is within a budget. If so then the customer may send confirmatory information to the supplier to complete the transaction.

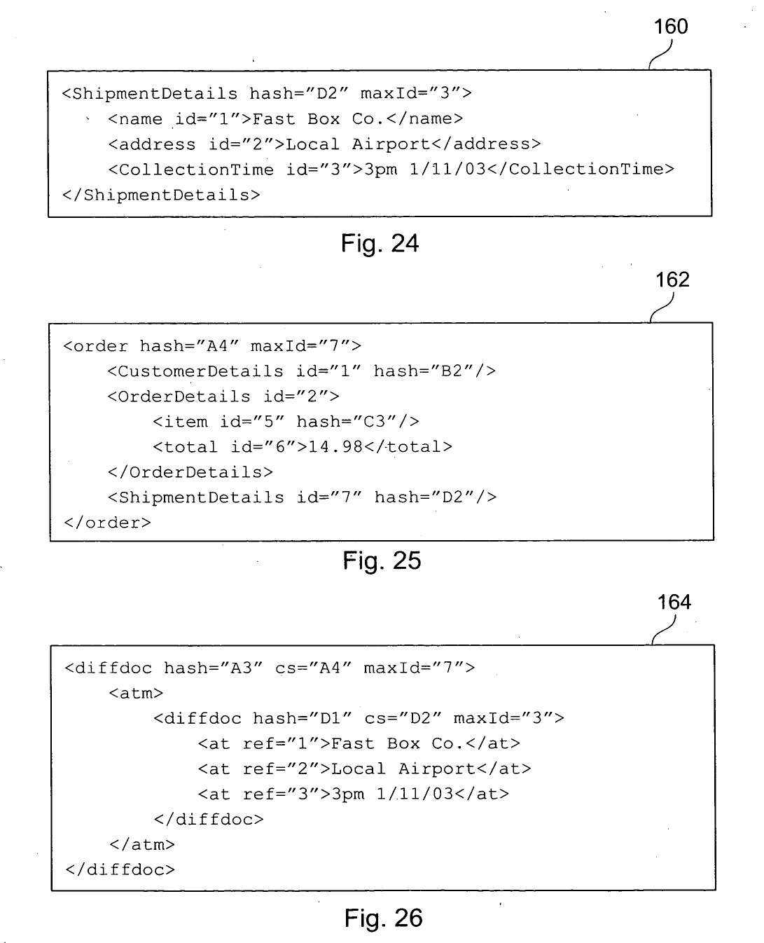

In the present example, the customer 30 confirms the transaction by sending a shipping address to the supplier 32. The customer therefore updates the most up-to-date version of the ShipmentDetails template, which is the original template 40, to include the customer's shipment details. FIG. 24 shows an example of an updated ShipmentDetails template 160. The customer 30 has added appropriate text nodes to the empty elements in the template 40 to produce the updated template 160. The customer 30 also adds a link to the updated ShipmentDetails template 160, which has the hash “D2,” to the master template 140. The updated master template 162 is shown in FIG. 25. The new link is shown in line 7 as the ShipmentDetails element. The element is given the “id” value of “7” which is one greater than the previous value of “maxId,” found in the root element of the previous version of the master template 140, shown in FIG. 21. The “maxId” and hash values in the root element are updated accordingly, and are shown in the root element of the updated master template 162 of FIG. 25. The new hash value is “A4” and incorporates the hash value “D2” of the updated ShipmentDetails element 160, as this value is present in the link in line 7 of the updated master template 162. The customer 30 retains an original copy of the ShipmentDetails template 40.

The customer 30 then generates a third diffdoc 164, as shown in FIG. 26, using the full three-stage process. The top-level diffdoc is to be applied to the template with the hash “A3,” which is the master template 140 shown in FIG. 21, and contains a single “atm” instruction element. The instruction when carried out adds a link element to the master template 140. The instruction element does not contain a “ref” attribute. Therefore, it follows a default behaviour which is to add the link element as a child of the root of the master template 140. Default behaviours are shown in the table of FIGS. 16A-16B in the “Default behaviour” column.

The “atm” instruction element contains a further diffdoc, found in lines 3 to 7 of FIG. 26. Therefore, the instruction adds a link to the master template 140 which points to the further template modified by this further diffdoc. The further template to be modified has the hash “D1,” therefore it is the original ShipmentDetails template 40 shown in FIG. 10. This is the most up-to-date version of this template as it has not been modified by either of the previous diffdocs 44, 144.

The further diffdoc contains instructions which, when carried out, modify the ShipmentDetails template 40 with the hash “D1” to produce the template 160 shown in FIG. 24 with the hash “D2.” The hash of the modified further template 160 can be checked against the “cs” attribute value of the “root” element (which is not a true XML root element) of the further diffdoc in line 3 of FIG. 26.

The further diffdoc contains three “at” instructions which add text nodes to empty elements within the ShipmentDetails template 40. Once the customer 30 has produced the third diffdoc 164, he or she sends it to the supplier 32 as shown in FIG. 6. The supplier 32 then carries out the instructions in the diffdoc 164 to produce the master template 162 of FIG. 25 and the ShipmentDetails template 160 of FIG. 24. The customer 30 and supplier 32 are therefore in possession of the most up-to-date versions of the master template 162 shown in FIG. 25, CustomerDetails template 132 shown in FIG. 19, item template 142 shown in FIG. 22, and ShipmentDetails template 160 shown in FIG. 24. The supplier 32 retains an original copy of the ShipmentDetails template 40.

The supplier 32 then may take the necessary action to complete the customer's order, such as shipping the requested products to the shipping address given in the ShipmentDetails template 162. As regards billing, the customer 30 and supplier 32 may have a pre-arranged agreement, or the supplier 32 may send an invoice to the shipping address. Alternatively, the exchange of communication between the customer 30 and supplier 32 could have included billing details, for example in another further template with a link in the master template.

The above described embodiment of the present disclosure is suitable for use in an exchange of communications between two parties, or when a third party possesses the original templates 34, 36, 38, 40 and receives all communications from both the customer 30 and supplier 32. In particular, the third party receives all diffdocs 44, 144, 164 and can therefore regenerate all of the information in the transaction.

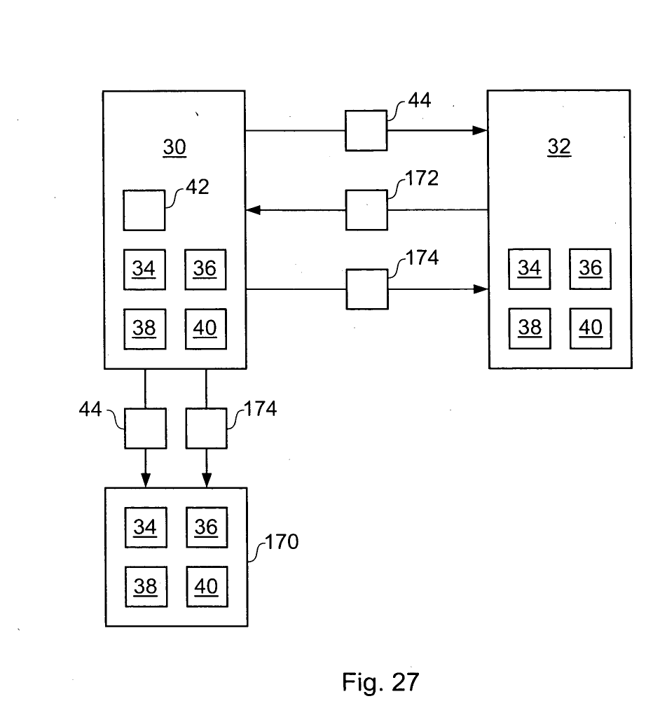

In a second embodiment, the embodiment can be used for exchanging information between multiple parties, wherein the parties do not necessarily receive all communications. An example of a situation in which this embodiment may be used is shown in FIG. 27. This example is an extension of the example of FIG. 6. The customer 30 and supplier 32 are in possession of the original templates 34, 36, 38, 40. A third party 170 is also in possession of these templates. The third party 170 may be, for example, a records system which must keep a record of all communications sent from the customer 30 to the supplier 32, and is remote from the customer 30. The records system 170 must keep a record of the complete communication, and not just the changes in a communication indicated by second and third diffdocs 144, 164. As such, a communication may omit details which the supplier 32 possesses but nevertheless form a part of the communication when reconstructed by the supplier 32.

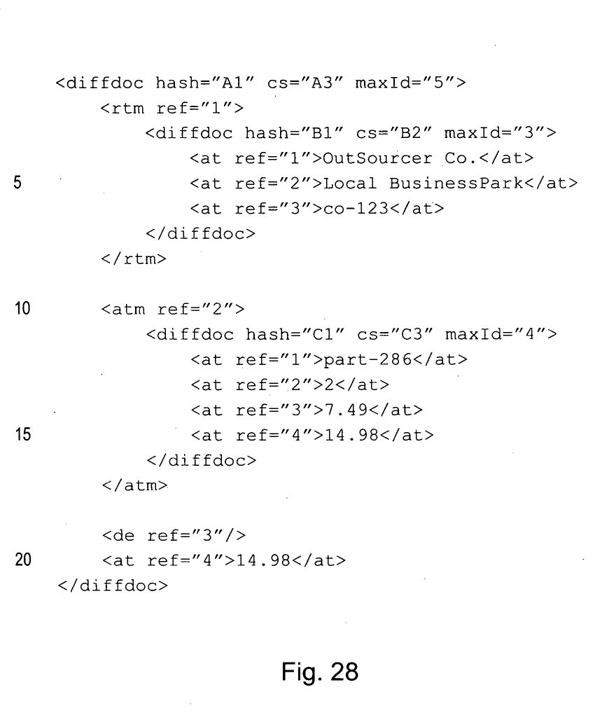

The customer 30 produces an order document 42, as above. The customer 30 also produces the diffdoc 44 as shown in FIG. 11, and sends it to both the supplier 32 and the third party 170. The supplier 32 and third party 170 then apply the instructions in the diffdoc 44 to produce data within the templates 34, 36, 38, 40 corresponding to data within the order document 42, as above. All parties retain unamended copies of the original templates 34, 36, 38, 40. Therefore, the supplier 32 and third party 170 are in possession of templates 130, 132, 134, 40 which contain up-to-date information. The supplier 32 then updates the templates 130, 132, 134, 40 to produce modified versions of the templates 140, 132, 142, 40. The supplier 32 generates new diffdoc 172, shown in FIG. 28, which contains instructions for modifying the original templates 34, 36, 38, 40 to produce the up-to-date templates 140, 132, 142, 40. This contrasts with the first-described embodiment of the present disclosure, where the second diffdoc 144 contained instructions to modify the templates 130, 132, 134, 40 in order to produce the templates 140, 132, 142, 40.

In other words, the new diffdoc 172 is similar to a combination of the diffdocs 44, 144 from the first embodiment. However the new diffdoc does not merely contain all instructions from both diffdocs. For example, the first diffdoc 44 contains instructions to delete the “price” and “SubTotal” elements from the item template 38. These instructions are found in lines 14 and 15 of the diffdoc 44 in FIG. 11. The second diffdoc 144 in the first embodiment contains instructions to re-insert these elements with data, as shown in lines 4 and 5 in FIG. 23. The second diffdoc 172 of the second embodiment of the present disclosure instead contains instructions to add data to the empty elements in the original item template 38. These instructions are found in lines 14 and 15 of FIG. 28.

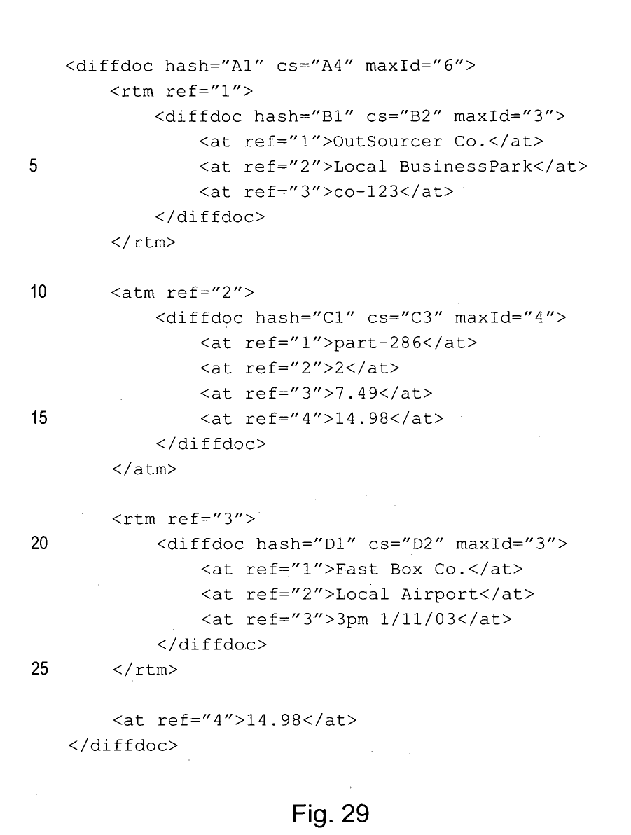

The supplier 32, once the diffdoc 172 has been produced, sends the diffdoc 172 to the customer 30, who uses it to produce the updated templates 140, 132, 142, 40 from the original templates 34, 36, 38, 40. The customer 30 then updates the templates 140, 132, 142, 40 to produce the templates 162, 132, 142, 160. The customer produces a third diffdoc 174, shown in FIG. 29, which contains instructions for modifying the original templates 34, 36, 38, 40 to produce up-to-date templates 162, 132, 142, 160. The customer sends this diffdoc to both the third party 170 and the supplier 32 who may then produce the up-to-date templates 162, 132, 142, 160 from the original templates 34, 36, 38, 40.

The second embodiment of the present disclosure can also be used to distribute updates of a document to multiple users of that document, when the users may each possess a different version of the document. An author of the document may distribute a diffdoc to the users instead of the whole document. The diffdoc would contain instructions to modify the originally distributed document to form the most up-to-date version. Alternatively, the diffdoc may contain instructions to modify a generic template. In either situation, a reduced amount of information can be transmitted. In one preferred embodiment, the diffdoc contains instructions to modify the originally distributed document, so that the diffdoc does not contain information that must be in the possession of all users. However, this would require each user to retain the original document.

The second embodiment of the present disclosure is also useful when an owner of a document receives updates from a number of independent users—for example, software developers. Each user would update a document, and submit a diffdoc to the owner containing instructions to modify the original to produce that owner's updated version. If whole updated documents are submitted by the users, then a larger amount of information is transmitted, and the owner must first examine each updated document along with the original to determine the changes, before the original document can be updated to incorporate changes from all users. Embodiments of the present disclosure present to the owner a list of changes made by each user, in the form of a diffdoc. The owner can then apply the instructions in each diffdoc in turn to the original document in order to incorporate all changes, provided that changes by the users do not overlap or that such overlapping changes can be resolved. The owner may subsequently distribute a diffdoc to update the original document held by each user to produce an updated document including changes from multiple users.

The first and second embodiments of the present disclosure can be combined where appropriate. For example, in the situation shown in FIG. 27, instead of the supplier 32 sending the second diffdoc 172 of the second embodiment to the customer 30, the supplier 32 could instead send the second diffdoc 144 of the first embodiment. This second diffdoc 144 may omit instructions from the first diffdoc 44 and, hence, may be smaller than the second diffdoc 172 from the second embodiment. A sender may use the first embodiment (where a diffdoc updates the most recent versions of a template) when there is only one recipient or when all recipients definitely possess the most up-to-date versions of the required templates. Otherwise, the second embodiment may be used (where a diffdoc always updates the original templates 34, 36, 38, 40).

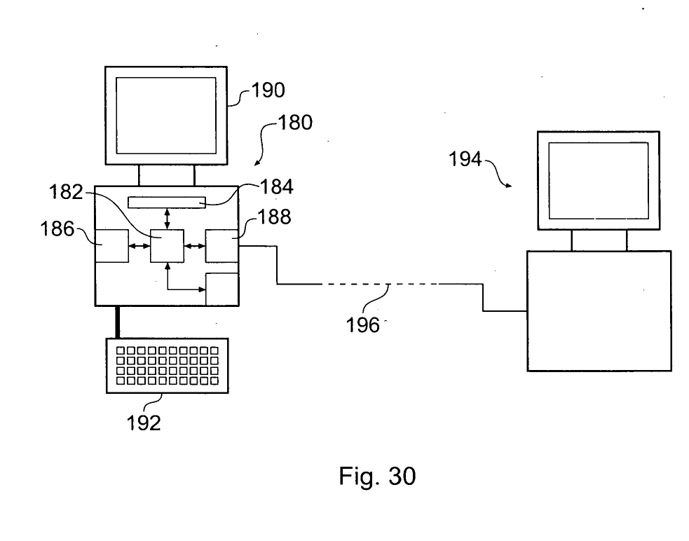

Various embodiments of the present disclosure can be implemented on a computer system 180 such as that shown in FIG. 30. The computer system 180 comprises a data processor 182, which is in communication with a memory 184, permanent storage system 186, and communications device 188. The computer system 180 also comprises a display 190 and an input device 192, such as a keyboard.

The computer system 180 is in communication with a second computer system 194 via the communications device 188 and communication link 196. The link 196 may be a network, internet, wireless, or other link. Thus, the computer systems 180, 194 can exchange information, including diffdocs. It is thus possible to provide an efficient mechanism for exchanging changes in data.

Various embodiments of the present disclosure, where appropriate, include:
a method of reconstructing a first data object, comprising the steps of:
   a) identifying at least one template from a further data object; and
   b) applying respective differences identified in the further data object to the at least one template in order to reconstruct the first data object.

In some embodiments, there are a plurality of templates and at least one of the templates identifies at least one further template, and the step of applying the respective differences to the templates comprises applying the respective differences to the at least one of the templates and the at least one further template

In various embodiments, there are a plurality of templates and the first data object, when reconstructed, comprises a plurality of parts arranged in a hierarchical fashion, and at least one of the parts identifies at least one more of the parts.

In some embodiments, the step of applying the respective differences comprises applying selected respective differences to an identified one of the templates to produce one of the parts.

In various embodiments, the step of applying the respective differences comprises the steps of:
a) identifying from the respective differences at least one item of data structure and/or data content to be added to, deleted from, or modified in the at least one template; and
b) adding, deleting or modifying respectively the at least one item in the at least one template.

In one exemplary form of the method, there are a plurality of templates and the step of applying the respective differences comprises the steps of:
a) identifying from the respective differences at least one item of data structure having data content to be added to one of the templates wherein the data content identifies one or more of the templates; and
b) adding the at least one item to the template.

In various embodiments, each respective difference is applied to an item of data structure, or of data content within an item of data structure, and the respective difference identifies the item of data structure. Each respective difference, in some embodiments, identifies an identifier of the item to which it is to be applied, and the identifier is unique within the template containing that data item.

In one exemplary form of the method, there are a plurality of templates and the further data object comprises a plurality of sub-sections arranged in a hierarchical fashion—each sub-section containing respective differences to be applied to one of the templates and an identification of that template, and the step of applying the respective differences comprises applying the respective differences in each sub-section to the template identified in that sub-section.

Yet, further embodiments of the present disclosure include a data processor arranged to reconstruct a first data object, in which the data processor is arranged to:
a) identify at least one template from a further data object; and
b) apply respective differences identified in the further data object to the at least one template in order to reconstruct the first data object.

In some embodiments, there are a plurality of templates and at least one of the templates identifies at least one further template, and the data processor is arranged to apply the respective differences to the at least one of the templates and the at least one further template.

Yet a further preferred embodiment includes a method of exchanging information between a first party and a second party, where the first and second parties each possess a copy of at least one template, and the first party possesses a first data object which comprises or is mapable onto the at least one template together with respective differences to be applied to the at least one template, and one embodiment of the method comprises the steps of:
a) the first party determining the respective differences to be applied to the at least one template;
b) the first party forming a first difference data object identifying the at least one template together with the respective differences to be applied to the at least one template that allow the first data object to be reconstructed;
c) the first party sending the first difference data object to the second party;
d) the second party reconstructing the first data object to form a first reconstructed data object;
e) the second party producing a second data object which comprises or is mapable onto the first reconstructed data object together with respective differences to be applied to the first reconstructed data object;
f) the second party determining the respective differences to be applied to the first reconstructed data object; and
g) the second party forming a second difference data object which identifies the first reconstructed data object together with the respective differences to be applied to the first data object that allow the second data object to be reconstructed.

In an exemplary embodiment, the method further comprises the steps of:
a) the second party sending the second compressed data object to the first party; and
b) the first party reconstructing the second data object.

1. A method of compressing a first data object, comprising the steps of:
determining respective differences to be applied to at least one template that allow the first data object to be reconstructed; and
forming a further data object identifying the at least one template together with the respective differences to be applied to the at least one template.

2. A method as claimed in claim 1, in which there are a plurality of templates, and in which at least one of the templates identifies at least one further template, and the respective differences are to be applied to the at least one of the templates and the at least one further template.

3. A method as claimed in claim 1, in which there are a plurality of templates and in which the first data object comprises at least two parts, and each part comprises one of the templates together with respective differences applied to that template.

4. A method as claimed in claim 3, in which at least one of the parts identifies at least one more of the parts in a hierarchical fashion.

5. A method as claimed in claim 1, in which the respective differences include at least one indication of an item of data structure and data content which is to be modified in the at least one template.

6. A method as claimed in claim 1, in which there are a plurality of templates, the respective differences include at least one indication of an item of data structure having data content to be added to one of the templates, and the data content identifies at least one further template.

7. A method as claimed in claim 1, in which an item of data structure within one of the at least one template is associated with an identifier which is unique within that template, and each respective difference identifies the identifier of the item of data structure to which the respective difference is to be applied.

8. A method as claimed in claim 1, in which each template includes a unique identification, and the further data object identifies the unique identification of each template to which the respective differences are to be applied.

9. A method as claimed in claim 8, in which the unique identification of each template is a hash value of that template.

10. A method as claimed in claim 1, in which there are a plurality of templates and in which the further data object comprises a plurality of sub-sections arranged in a hierarchical fashion, each sub-section containing respective differences to be applied to one of the templates and an identification of that template.

11. A method as claimed in claim 1, further comprising the step of sending the further data object to one or more recipients.

12. A method as claimed in claim 1, in which at least one of the first data object, the further data object, and the at least one template is in XML format.

13. A data processor arranged to compress a first data object, wherein the data processor is arranged to:
determine respective differences to be applied to at least one template that allow the first data object to be reconstructed; and
form a further data object identifying the at least one template together with the respective differences to be applied to the at least one template.

14. A data processor as claimed in claim 13, in which there are a plurality of templates, and the data processor is arranged to form the further data object including respective differences to be applied to the templates.

15. A data processor as claimed in claim 14, in which at least one of the templates identifies at least one further template, and the data processor is arranged to form the further data object including respective differences to be applied to the at least one of the templates and the at least one further template.

16. A data processor as claimed in claim 13, in which the data processor includes within the further data object at least one indication of an item of data structure and data content to be modified in the at least one template.

17. A data processor as claimed in claim 14, in which the data processor includes within the further data object at least one indication of an item of data structure having data content to be added to one of the templates, and the data content identifies at least one more of the templates.

18. A data processor as claimed in claim 13, in which the data processor includes within the further data object respective differences, wherein each respective difference identifies a data item within a template, the respective difference being applied to the data item.

19. A data processor as claimed in claim 18, in which an item of data structure within one of the at least one template is associated with an identifier which is unique within that template, and the data processor includes within the further data object respective differences, wherein each respective difference identifies the identifier of the item to which the respective difference is to be applied.

20. A data processor as claimed in claim 13, in which each of the at least one template includes a unique identification, and the data processor includes within the further data object the unique identification of the at least one template to which the respective differences are to be applied.

21. A data processor as claimed in claim 14, in which the data processor forms the further data object with a plurality of sub-sections arranged in a hierarchical fashion, each sub-section containing respective differences to be applied to one of the templates and an identification of that template.

22. A data processor as claimed in claim 13, further arranged to send the compressed data object to at least one recipient.

23. A computer program for controlling a programmable data processor to perform the method as claimed in claim 1.

24. A data carrier including the computer program as claimed in claim 23.
